(19) United States
(12) Patent Application Publication
(10) Pub. No.: US 2026/0267884 A1
(43) Pub. Date: Sep. 10, 2026

(54) DIALOGUE PROCESSING METHOD

(71) Applicant: Tencent Technology (Shenzhen) Company Limited, Shenzhen (CN)

(72) Inventors: Yitong SU, Shenzhen (CN); Guhua ZHANG, Shenzhen (CN); Bin HUANG, Shenzhen (CN)

(73) Assignee: Tencent Technology (Shenzhen) Company Limited, Shenzhen (CN)

(21) Appl. No.: 19/551,548

(22) Filed: Feb. 26, 2026

Related U.S. Application Data
(63) Continuation of application No. PCT/CN2024/109873, filed on Aug. 5, 2024.

(30) Foreign Application Priority Data
Nov. 10, 2023 (CN) 202311493946.1

(51) Int. Cl. G06F 16/3329; G06F 16/35

(52) U.S. Cl. CPC G06F 16/33295; G06F 16/35

(57) ABSTRACT

In a dialogue processing method, a dialogue request is obtained, the dialogue request including an inquiry statement. A dialogue service type is obtained based on the dialogue request. A dialogue configuration parameter set and a plurality of pieces of pattern description information are obtained based on the dialogue service type, each of the plurality of pieces of pattern description information including respective pattern compression information and respective compression offset information. In this method, the inquiry statement is matched with each of the plurality of pieces of pattern description information, to obtain one or more pieces of candidate pattern description information. The one or more pieces of candidate pattern description information are screened based on the dialogue configuration parameter set to obtain target pattern description information. A reply statement associated with the target pattern description information is output in response to the dialogue request.

### RELATED APPLICATIONS

The present application is a continuation of International Application No. PCT/CN2024/109873, filed on Aug. 5, 2024, which claims priority to Chinese Patent Application No. 202311493946.1, filed on Nov. 10, 2023, and entitled “DIALOGUE METHOD AND APPARATUS, COMPUTER DEVICE, AND STORAGE MEDIUM.” The entire disclosures of the prior applications are hereby incorporated by reference.

### FIELD OF THE TECHNOLOGY

This disclosure relates to the field of computer technologies, including a dialogue processing method and apparatus, a computer device, a storage medium, and a computer program product.

### BACKGROUND OF THE DISCLOSURE

With the development of intelligent dialogue technology, pattern matching technology has emerged. Pattern matching is a rule-based matching method that is configured for matching an input from a requesting party with a predefined pattern or template, and then outputting the most matching reply as an output. Currently, the pre-defined pattern or template is usually saved to a matching library, and pattern matching is performed through the matching library. However, when a quantity of patterns in the matching library is relatively large, a large amount of time usually needs to be consumed for matching with the patterns in the matching library, resulting in a decrease in dialogue efficiency.

### SUMMARY

Accordingly, the present disclosure provides a dialogue processing method and apparatus, a computer device, a computer-readable storage medium, and a computer program product that can improve dialogue matching efficiency.

According to one aspect, this disclosure provides a dialogue processing method. In this method, a dialogue request is obtained, the dialogue request including an inquiry statement. A dialogue service type is obtained based on the dialogue request. A dialogue configuration parameter set and a plurality of pieces of pattern description information are obtained based on the dialogue service type, each of the plurality of pieces of pattern description information including respective pattern compression information and respective compression offset information. In this method, for each of the plurality of pieces of pattern description information, the pattern compression information is obtained by performing state transition on respective dialogue pattern information through a deterministic finite automaton (DFA) to obtain dialogue pattern state transition information and compressing target information in the dialogue pattern state transition information and shifted non-target information in the dialogue pattern state transition information, and the compression offset information indicates an offset of the shifted non-target information. In this method, the inquiry statement is matched with each of the plurality of pieces of pattern description information based on the respective pattern compression information and the respective compression offset information, to obtain one or more pieces of candidate pattern description information. The one or more pieces of candidate pattern description information are screened by processing circuitry based on the dialogue configuration parameter set to obtain target pattern description information. A reply statement associated with the target pattern description information is output by the processing circuitry in response to the dialogue request.

According to another aspect, this disclosure provides a dialogue processing apparatus. The apparatus includes processing circuitry configured to obtain a dialogue request, the dialogue request including an inquiry statement. The processing circuitry is configured to obtain a dialogue service type based on the dialogue request, and obtain a dialogue configuration parameter set and a plurality of pieces of pattern description information based on the dialogue service type, each of the plurality of pieces of pattern description information including respective pattern compression information and respective compression offset information. For each of the plurality of pieces of pattern description information, the pattern compression information is obtained by performing state transition on respective dialogue pattern information through a deterministic finite automaton (DFA) to obtain dialogue pattern state transition information and compressing target information in the dialogue pattern state transition information and shifted non-target information in the dialogue pattern state transition information, and the compression offset information indicates an offset of the shifted non-target information. The processing circuitry is configured to match the inquiry statement with each of the plurality of pieces of pattern description information based on the respective pattern compression information and the respective compression offset information, to obtain one or more pieces of candidate pattern description information. The processing circuitry is configured to screen the one or more pieces of candidate pattern description information based on the dialogue configuration parameter set to obtain target pattern description information; and output a reply statement associated with the target pattern description information in response to the dialogue request.

According to another aspect, this disclosure provides a non-transitory computer-readable storage medium storing instructions, which when executed by a processor, cause the processor to perform a dialogue processing method. In this method, a dialogue request is obtained, the dialogue request including an inquiry statement. A dialogue service type is obtained based on the dialogue request. A dialogue configuration parameter set and a plurality of pieces of pattern description information are obtained based on the dialogue service type, each of the plurality of pieces of pattern description information including respective pattern compression information and respective compression offset information. In this method, for each of the plurality of pieces of pattern description information, the pattern compression information is obtained by performing state transition on respective dialogue pattern information through a deterministic finite automaton (DFA) to obtain dialogue pattern state transition information and compressing target information in the dialogue pattern state transition information and shifted non-target information in the dialogue pattern state transition information, and the compression offset information indicates an offset of the shifted non-target information. In this method, the inquiry statement is matched with each of the plurality of pieces of pattern description information based on the respective pattern compression information and the respective compression offset information, to obtain one or more pieces of candidate pattern description information. The one or more pieces of candidate pattern description information are screened based on the dialogue configuration parameter set to obtain target pattern description information. A reply statement associated with the target pattern description information is output in response to the dialogue request.

According to another aspect, this disclosure provides a dialogue method. The method includes: obtaining a dialogue request, the dialogue request carrying an inquiry statement; obtaining a dialogue service type based on the dialogue request, and obtaining a corresponding dialogue configuration parameter and a plurality of pieces of pattern description information based on the dialogue service type, the pattern description information including pattern compression information and compression offset information, the pattern compression information being obtained by performing state transition on the dialogue pattern information through a deterministic finite automaton (DFA) to obtain dialogue pattern state transition information and compressing target information in the dialogue pattern state transition information through non-target information in the dialogue pattern state transition information, and the compression offset information being configured for characterizing an offset of the non-target information in the dialogue pattern state transition information; matching the inquiry statement with the plurality of pieces of pattern description information based on the pattern compression information and the compression offset information, to obtain a plurality of pieces of candidate pattern description information; and screening the plurality of pieces of candidate pattern description information based on the dialogue configuration parameter to obtain target pattern description information, obtaining a reply statement associated with the target pattern description information, and returning the reply statement to a requester side corresponding to the dialogue request.

According to another aspect, this disclosure further provides a dialogue apparatus. The apparatus includes: a request obtaining module, configured to obtain a dialogue request, the dialogue request carrying an inquiry statement; an information obtaining module, configured to obtain a dialogue service type based on the dialogue request, and obtain a corresponding dialogue configuration parameter and a plurality of pieces of pattern description information based on the dialogue service type, the pattern description information including pattern compression information and compression offset information, the pattern compression information being obtained by performing state transition on the dialogue pattern information through a DFA to obtain dialogue pattern state transition information and compressing target information in the dialogue pattern state transition information through non-target information in the dialogue pattern state transition information, and the compression offset information being configured for characterizing an offset of the non-target information in the dialogue pattern state transition information; a matching module, configured to match the inquiry statement with the plurality of pieces of pattern description information based on the pattern compression information and the compression offset information, to obtain a plurality of pieces of candidate pattern description information; and a reply module, configured to screen the plurality of pieces of candidate pattern description information based on the dialogue configuration parameter to obtain target pattern description information, obtain a reply statement associated with the target pattern description information, and return the reply statement to a requester side corresponding to the dialogue request.

According to another aspect, this disclosure further provides a computer device. The computer device includes a memory (e.g., a non-transitory computer readable storage medium) and processing circuitry (e.g., a processor), the memory having a computer program stored therein, the processor, when executing the computer program, implementing the following operations: obtaining a dialogue request, the dialogue request carrying an inquiry statement; obtaining a dialogue service type based on the dialogue request, and obtaining a corresponding dialogue configuration parameter and a plurality of pieces of pattern description information based on the dialogue service type, the pattern description information including pattern compression information and compression offset information, the pattern compression information being obtained by performing state transition on the dialogue pattern information through a DFA to obtain dialogue pattern state transition information and compressing target information in the dialogue pattern state transition information through non-target information in the dialogue pattern state transition information, and the compression offset information being configured for characterizing an offset of the non-target information in the dialogue pattern state transition information; matching the inquiry statement with the plurality of pieces of pattern description information based on the pattern compression information and the compression offset information, to obtain a plurality of pieces of candidate pattern description information; and screening the plurality of pieces of candidate pattern description information based on the dialogue configuration parameter to obtain target pattern description information, obtaining a reply statement associated with the target pattern description information, and returning the reply statement to a requester side corresponding to the dialogue request.

According to a fourth aspect, this disclosure further provides a non-transitory computer-readable storage medium. The non-transitory computer-readable storage medium has a computer program stored therein, the computer program, when executed by processing circuitry (e.g., a processor), implementing the following operations: obtaining a dialogue request, the dialogue request carrying an inquiry statement; obtaining a dialogue service type based on the dialogue request, and obtaining a corresponding dialogue configuration parameter and a plurality of pieces of pattern description information based on the dialogue service type, the pattern description information including pattern compression information and compression offset information, the pattern compression information being obtained by performing state transition on the dialogue pattern information through a DFA to obtain dialogue pattern state transition information and compressing target information in the dialogue pattern state transition information through non-target information in the dialogue pattern state transition information, and the compression offset information being configured for characterizing an offset of the non-target information in the dialogue pattern state transition information; matching the inquiry statement with the plurality of pieces of pattern description information based on the pattern compression information and the compression offset information, to obtain a plurality of pieces of candidate pattern description information; and screening the plurality of pieces of candidate pattern description information based on the dialogue configuration parameter to obtain target pattern description information, obtaining a reply statement associated with the target pattern description information, and returning the reply statement to a requester side corresponding to the dialogue request.

According to another aspect, this disclosure further provides a computer program product. The computer program product includes a computer program, the computer program, when executed by processing circuitry (e.g., a processor), implementing the following operations: obtaining a dialogue request, the dialogue request carrying an inquiry statement; obtaining a dialogue service type based on the dialogue request, and obtaining a corresponding dialogue configuration parameter and a plurality of pieces of pattern description information based on the dialogue service type, the pattern description information including pattern compression information and compression offset information, the pattern compression information being obtained by performing state transition on the dialogue pattern information through a DFA to obtain dialogue pattern state transition information and compressing target information in the dialogue pattern state transition information through non-target information in the dialogue pattern state transition information, and the compression offset information being configured for characterizing an offset of the non-target information in the dialogue pattern state transition information; matching the inquiry statement with the plurality of pieces of pattern description information based on the pattern compression information and the compression offset information, to obtain a plurality of pieces of candidate pattern description information; and screening the plurality of pieces of candidate pattern description information based on the dialogue configuration parameter to obtain target pattern description information, obtaining a reply statement associated with the target pattern description information, and returning the reply statement to a requester side corresponding to the dialogue request.

According to the dialogue processing method and apparatus, the computer device, the storage medium, and the computer program product described above, state transition is performed on the dialogue pattern information through a DFA to obtain the dialogue pattern state transition information, the target information in the dialogue pattern state transition information is compressed through the non-target information to obtain the pattern compression information, and the compression offset information is obtained based on the offset of the non-target information in the dialogue pattern state transition information. Then the dialogue request is obtained, and the corresponding dialogue configuration parameter and the plurality of pieces of pattern description information are obtained based on the dialogue service type of the dialogue request. Then the inquiry statement is matched with the plurality of pieces of pattern description information based on the pattern compression information and the compression offset information included in the pattern description information, thereby greatly narrowing the search range during the matching, improving the execution efficiency of the matching, and further improving the efficiency of obtaining the reply statement, i.e., improving the dialogue efficiency. In addition, the dialogue pattern information respectively corresponding to the plurality of pieces of candidate pattern description information is screened based on the dialogue configuration parameter, thereby enabling refined control over the matching process and improving the flexibility of the matching.

### BRIEF DESCRIPTION OF THE DRAWINGS

To describe technical solutions of embodiments of this disclosure, the accompanying drawings are briefly described below. The accompanying drawings in the following description show only some aspects of this disclosure.

FIG. 1 is a diagram of an disclosure environment of a dialogue method according to an embodiment.

FIG. 2 is a schematic flowchart of a dialogue method according to an embodiment.

FIG. 3 is a schematic flowchart of obtaining pattern description information according to an embodiment.

FIG. 4 is a schematic diagram of dialogue pattern state transition information according to a specific embodiment.

FIG. 5 is a schematic diagram of offset dialogue pattern state transition information according to a specific embodiment.

FIG. 6 is a schematic diagram of pattern description information according to a specific embodiment.

FIG. 7 is a schematic diagram of obtaining dialogue pattern state transition information according to a specific embodiment.

FIG. 8 is a schematic diagram of a dialogue service creation page according to a specific embodiment.

FIG. 9 is a schematic diagram of a query configuration page according to a specific embodiment.

FIG. 10 is a schematic diagram of an intent configuration page according to a specific embodiment.

FIG. 11 is a schematic diagram of a dialogue service creation page according to another specific embodiment.

FIG. 12 is a schematic diagram of a page of a classification model configuration according to a specific embodiment.

FIG. 13 is a schematic diagram of a decoration service dialogue according to a specific embodiment.

FIG. 14 is a schematic diagram flowchart of a decoration service dialogue according to a specific embodiment.

FIG. 15 is a schematic flowchart of obtaining candidate pattern description information according to an embodiment.

FIG. 16 is a schematic diagram of music dialogue matching according to a specific embodiment.

FIG. 17 is a schematic diagram of obtaining final intent information according to a specific embodiment.

FIG. 18 is a schematic flowchart of a dialogue method according to a specific embodiment.

FIG. 19 is a schematic diagram of an overall structure of a dialogue platform according to a specific embodiment.

FIG. 20 is a schematic diagram of an overall structure of dialogue matching according to a specific embodiment.

FIG. 21 is a schematic diagram of a specific structure of dialogue matching according to a specific embodiment.

FIG. 22 is a structural block diagram of a dialogue apparatus according to an embodiment.

FIG. 23 is an internal structure diagram of a computer device according to an embodiment.

FIG. 24 is a diagram of an internal structure of a computer device according to an embodiment.

### DESCRIPTION OF EMBODIMENTS

To describe objectives, technical solutions, and advantages of this disclosure, this disclosure is further described below with reference to the accompanying drawings and embodiments. Specific embodiments described herein are merely intended to explain this disclosure, and are not intended to limit this disclosure. Other embodiments are within the scope of this disclosure.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

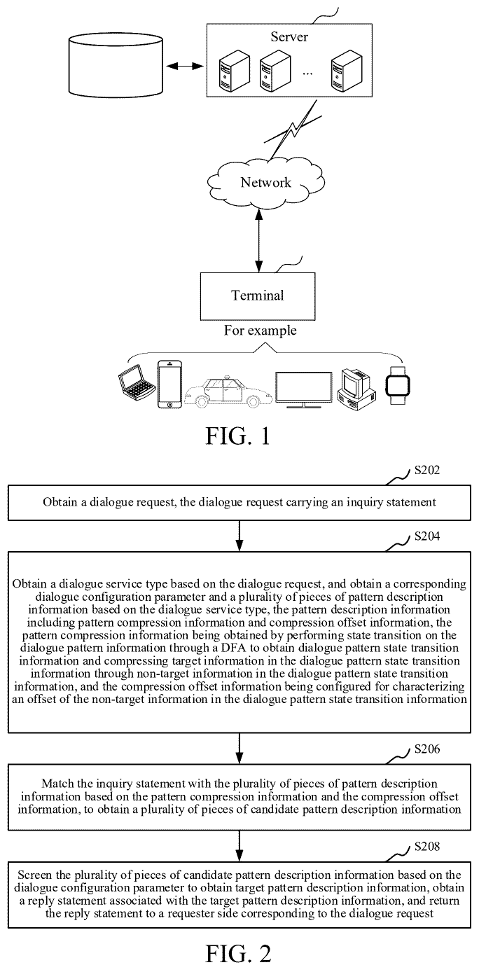

The dialogue method provided in an embodiment of this disclosure may be applied to an application environment shown in FIG. 1. A terminal 102 communicates with a server 104 through a network. A data storage system may store data to be processed by the server 104. The data storage system may be integrated on the server 104, or may be arranged on the cloud or another server. The server 104 is configured to obtain a dialogue request transmitted by a terminal 102, the dialogue request carrying an inquiry statement. The server 104 obtains a dialogue service type based on the dialogue request, and obtains a corresponding dialogue configuration parameter and a plurality of pieces of pattern description information based on the dialogue service type, the pattern description information including pattern compression information and compression offset information, the pattern compression information being obtained by performing state transition on the dialogue pattern information through a deterministic finite automaton (DFA) to obtain dialogue pattern state transition information and compressing target information in the dialogue pattern state transition information through non-target information in the dialogue pattern state transition information, and the compression offset information being configured for characterizing an offset of the non-target information in the dialogue pattern state transition information. The server 104 matches the inquiry statement with the plurality of pieces of pattern description information based on the pattern compression information and the compression offset information, to obtain a plurality of pieces of candidate pattern description information. The server 104 screens the plurality of piece of candidate pattern description information based on the dialogue configuration parameter to obtain target pattern description information, obtains a reply statement associated with the target pattern description information, and returns the reply statement to a requester side corresponding to a dialogue request. The requester side may be a terminal 102, or may be a server, or the like. The terminal 102 may be, but is not limited to, various desktop computers, notebook computers, smartphones, tablet computers, Internet of Things devices, and portable wearable devices. The Internet of Thing devices may be a smart speaker, a smart television, a smart air conditioner, a smart onboard device, and the like. The portable wearable device may be a smartwatch, a smart bracelet, a head-mounted device, and the like. The server 104 may be an independent physical server, or may be a server cluster composed of a plurality of physical servers or a distributed system, and may further be a cloud server providing a cloud computing service. The terminal and the server may be directly or indirectly connected through wired or wireless communication, which is not limited herein in this disclosure.

In an embodiment, as shown in FIG. 2, a dialogue method is provided. An example in which the method is applied to the server in FIG. 1 is used for description. This embodiment is described by using the example in which the method is applied to the server. The method may also be applied to a terminal, may further be applied to a system that includes a terminal and a server, and is implemented through interaction of the terminal and the server. In this embodiment, the method includes the following operations.

S202: Obtain a dialogue request, the dialogue request carrying or including an inquiry statement.

The dialogue request is a request for making a dialogue. The dialogue request may be triggered by a chatbot, which is a computer program that conducts a conversation through a dialogue or texts. The chatbot can simulate human conversations and pass the Turing test. The chatbot may be configured for a practical purpose, such as customer service or information retrieval. The inquiry statement is an input statement when an inquiry dialogue is performed. The inquiry statement may be a statement in any language, or may be a statement in any one of all languages. For example, the language may be Chinese, Japanese, Russian, or English. The inquiry statement may be an interrogative sentence, a declarative sentence, an imperative sentence, an exclamatory sentence, or the like.

Specifically, the server may obtain, in real time, a dialogue request transmitted by a terminal through the chatbot, and parse the dialogue request to obtain a carried inquiry statement. The terminal may also obtain a dialogue voice in real time, and then the server obtains the dialogue voice transmitted by the terminal and transitions the dialogue voice to an inquiry statement. The server may also obtain a dialogue request transmitted by a serving party that provides a dialogue business service, and parse the dialogue request to obtain an inquiry statement therein.

S204: Obtain a dialogue service type based on the dialogue request, and obtain a corresponding dialogue configuration parameter and a plurality of pieces of pattern description information based on the dialogue service type, the pattern description information including pattern compression information and compression offset information, the pattern compression information being obtained by performing state transition on the dialogue pattern information through a DFA to obtain dialogue pattern state transition information and compressing target information in the dialogue pattern state transition information through non-target information in the dialogue pattern state transition information, and the compression offset information being configured for characterizing an offset of the non-target information in the dialogue pattern state transition information.

For example, a dialogue service type is obtained based on the dialogue request. A dialogue configuration parameter set and a plurality of pieces of pattern description information are obtained based on the dialogue service type. In some embodiments, each of the plurality of pieces of pattern description information includes respective pattern compression information and respective compression offset information. In some embodiments, for each of the plurality of pieces of pattern description information, the pattern compression information is obtained by performing state transition on respective dialogue pattern information through a deterministic finite automaton (DFA) to obtain dialogue pattern state transition information and compressing target information in the dialogue pattern state transition information and shifted non-target information in the dialogue pattern state transition information, and the compression offset information indicates an offset of the shifted non-target information.

The dialogue service type is configured for characterizing a type of a provided dialogue service task. Different dialogue service tasks correspond to different dialogue service types. The dialogue service task refers to a task that provides a dialogue service. Different scenarios may provide different dialogue service tasks, different industries may provide different dialogue service tasks, different fields may provide different dialogue service tasks, and so on. For example, a decoration industry provides decoration-related dialogue service tasks, and the corresponding dialogue service type is a decoration dialogue service type. A catering field provides catering-related dialogue service tasks, and the corresponding dialogue service type is a catering dialogue service type. Different dialogue service types correspond to different dialogue configuration parameters and pattern description information. The dialogue configuration parameter is a pre-configured parameter for controlling dialogue matching. The pattern description information is configured for characterizing pre-configured dialogue pattern information. The dialogue pattern information may be a pre-configured regular expression character string configured for performing pattern matching. The pattern description information includes pattern compression information and compression offset information. The pattern compression information is obtained by performing state transition on dialogue pattern information to obtain dialogue pattern state transition information and compressing target information in the dialogue pattern state transition information. The compression offset information is configured for characterizing an offset of the non-target information in the dialogue pattern state transition information. The dialogue pattern state transition information is configured for characterizing state information corresponding to a character in the dialogue pattern information. The dialogue pattern state transition information refers to a reachability matrix of state information corresponding to the character in the dialogue pattern information. The target information is a target value in the dialogue pattern state transition information. The target information is information that can be overwritten by non-target information. For example, the target information may be a zero value, and the non-target information may be another value other than the zero value in the dialogue pattern state transition information. In some embodiments, the target information may be a value with the largest quantity in the dialogue pattern state transition information. In other words, the value with the largest quantity is compressed through the non-target information, thereby narrowing the range of matching search, improving efficiency of dialogue matching, and thus enhancing the dialogue efficiency. The non-target information refers to information in the dialogue pattern state transition information other than the target value. The target value may be zero. The pattern compression information refers to state transition information that includes only non-target information and obtained by compressing dialogue pattern state transition information. The pattern compression information may be a one-dimensional array. The compression offset information is configured for characterizing a position movement amount of the non-target information in the dialogue pattern state transition information during compression.

Specifically, the server obtains a dialogue configuration parameter corresponding to a dialogue service type and a plurality of pieces of dialogue pattern information, then performs state transition on each piece of dialogue pattern information through a DFA to obtain dialogue pattern state transition information, compresses target information in the dialogue pattern state transition information through non-target information to obtain pattern compression information, then determines compression offset information based on an offset of the non-target information in the dialogue pattern state transition information, and determines pattern description information corresponding to each piece of dialogue pattern information based on the pattern compression information and the compression offset information that correspond to each piece of dialogue pattern information. Then the server associatively saves the dialogue service type, the corresponding dialogue configuration parameter, and the plurality of pieces of pattern description information. The server may obtain a dialogue service type corresponding to a dialogue request based on a pre-configured dialogue service type of a chatbot. The server may also obtain a corresponding dialogue service type based on a chatbot identifier carried in the dialogue request. The server may also obtain a corresponding dialogue service type based on a requester side identifier carried in the dialogue request, or may obtain a dialogue service type based on a pre-configured association relationship between a requester side identifier and the dialogue service type. Then the server may find a corresponding dialogue configuration parameter and a plurality of pieces of pattern description information from a database based on the dialogue service type. The server may also find, based on the dialogue service type, the corresponding dialogue configuration parameter and a plurality of pieces of pattern description information from a server providing a data storage service.

S206: Match the inquiry statement with the plurality of pieces of pattern description information based on the pattern compression information and the compression offset information, to obtain a plurality of pieces of candidate pattern description information. For example, the inquiry statement is matched with each of the plurality of pieces of pattern description information (e.g., compared to determine the similarity therebetween) based on the respective pattern compression information and the respective compression offset information, to obtain one or more pieces of candidate pattern description information.

The candidate pattern description information is pattern description information that successfully matches the inquiry statement, and is the pattern description information that needs to be screened.

Specifically, the server searches the compression offset information for offset information of a state corresponding to each character in the inquiry statement, and then searches the pattern compression information for state information corresponding to each character in the inquiry statement based on the offset information. When the state information corresponding to all characters is found from the inquiry statement, it indicates that the dialogue pattern information corresponding to the pattern description information is successfully matched with a pattern of the inquiry statement. In this case, the corresponding pattern description information is used as the candidate pattern description information. The server performs pattern matching on each piece of pattern description information with the inquiry statement, and uses, as the candidate pattern description information, all of the pattern description information with a successful pattern matching, thereby obtaining a plurality of pieces of candidate pattern description information.

S208: Screen the plurality of pieces of candidate pattern description information based on the dialogue configuration parameter to obtain target pattern description information, obtain a reply statement associated with the target pattern description information, and return the reply statement to a requester side corresponding to the dialogue request. For example, the one or more pieces of candidate pattern description information are screened, by processing circuitry, based on the dialogue configuration parameter set to obtain target pattern description information. In some embodiments, a reply statement associated with the target pattern description information is output by the processing circuitry in response to the dialogue request at S202.

The target pattern description information refers to the pattern description information that is obtained through matching and characterizes the inquiry statement. The reply statement refers to a reply statement associated with dialogue pattern information corresponding to pre-configured target pattern description information.

Specifically, the server screens a plurality of pieces of candidate pattern description information based on the dialogue configuration parameter. The server may determine dialogue intents of the plurality of pieces of candidate pattern description information by using the dialogue configuration parameter, and then screen the dialogue intent of each piece of candidate pattern description information based on an intent screening parameter in the dialogue configuration parameter, so that the dialogue intent of screened target candidate pattern description information can best characterize an intent of the inquiry statement. Then the server obtains the reply statement associated with the target pattern description information based on a pre-configured association relationship between the dialogue pattern information corresponding to the pattern description information and the reply statement. Finally, the server returns the reply statement to the requester side corresponding to the dialogue request.

In an embodiment, S208 of screening the plurality of pieces of candidate pattern description information based on the dialogue configuration parameter to obtain target pattern description information, obtain a reply statement associated with the target pattern description information, and return the reply statement to a requester side corresponding to the dialogue request includes operations: performing slot filling on the dialogue pattern information respectively corresponding to the plurality of pieces of candidate pattern description information based on a slot filling parameter in the dialogue configuration parameter, to obtain a plurality of pieces of dialogue intent information, and screening the plurality of pieces of dialogue intent information based on an intent screening parameter in the dialogue configuration parameter, to obtain target dialogue intent information; and obtaining a reply statement associated with the target dialogue intent information, and returning the reply statement to the requester side corresponding to the dialogue request.

The slot refers to an identifier used in an inquiry statement to accurately express the key information of the intent. Slot filling refers to a process of supplementing slot information by transitioning dialogue pattern information to explicit dialogue intent information. The slot filling parameter refers to a control parameter used during the slot filling. The dialogue intent information refers to information that can characterize the intent corresponding to the inquiry statement, and may be a character string that matches the inquiry statement. The intent screening parameter refers to a control parameter used during screening of the dialogue intent information. The target dialogue intent information refers to dialogue intent information finally obtained through screening.

Specifically, the server obtains a plurality of pieces of candidate filling information corresponding to slots in the dialogue pattern information corresponding to each piece of candidate pattern description information, then allocates the plurality of pieces of candidate filling information by using the slot filling parameter in the dialogue configuration parameter, to obtain slot filling information, and then supplements the slot filling information to a slot in the dialogue pattern information, thereby obtaining the dialogue intent information corresponding to each piece of candidate pattern description information. Then the server may select, based on the intent screening parameter in the dialogue configuration parameter, dialogue intent information that best matches the plurality of pieces of dialogue intent information and the inquiry statement, and use the best-matched dialogue intent information as the target dialogue intent information. Then the server searches the database for a reply statement associated with the dialogue pattern information corresponding to the target dialogue intent information, and returns the reply statement to the requester side corresponding to the dialogue request. The requester side displays the reply statement. In an embodiment, the requester side may further input an inquiry statement based on the reply statement. In this case, the server obtains a new dialogue request, and responds to the dialogue request again, to obtain a new reply statement. To be specific, the server may perform multi-turn dialogues based on the dialogue method in the foregoing embodiments, thereby implementing dialogue flow services and improving dialogue service experience.

According to the dialogue method and apparatus, the computer device, the storage medium, and the computer program product described above, state transition is performed on the dialogue pattern information through a DFA to obtain the dialogue pattern state transition information, the target information in the dialogue pattern state transition information is compressed through the non-target information to obtain the pattern compression information, and the compression offset information is obtained based on the offset of the non-target information in the dialogue pattern state transition information. Then the dialogue request is obtained, and the corresponding dialogue configuration parameter and the plurality of pieces of pattern description information are obtained based on the dialogue service type of the dialogue request. Then the inquiry statement is matched with the plurality of pieces of pattern description information based on the pattern compression information and the compression offset information included in the pattern description information, thereby greatly narrowing the search range during the matching, improving the execution efficiency of the matching, and further improving the efficiency of obtaining the reply statement, i.e., improving the dialogue efficiency. In addition, the dialogue pattern information respectively corresponding to the plurality of pieces of candidate pattern description information is screened based on the dialogue configuration parameter, thereby enabling refined control over the matching process and improving the flexibility of the matching.

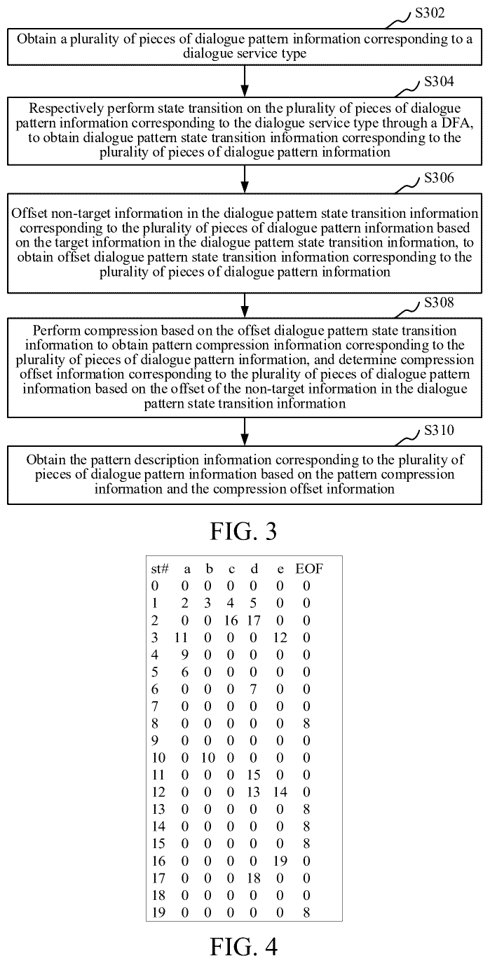

In an embodiment, as shown in FIG. 3, before operation S202, namely, before the obtaining a dialogue request, the dialogue request carrying an inquiry statement, the method further includes operations.

S302: Obtain a plurality of pieces of dialogue pattern information corresponding to the dialogue service type.

S304: Respectively perform state transition on the plurality of pieces of dialogue pattern information corresponding to the dialogue service type through the DFA, to obtain dialogue pattern state transition information respectively corresponding to the plurality of pieces of dialogue pattern information. For example, for each of the plurality of pieces of dialogue pattern information, the state transition is performed on the respective piece of dialogue pattern information through the DFA, to obtain the dialogue pattern state transition information corresponding to the respective piece of dialogue pattern information.

Specifically, the server obtains the plurality of pieces of dialogue pattern information corresponding to the dialogue service type from a database, and then respectively performs state transition on each piece of dialogue pattern information, to obtain dialogue pattern state transition information corresponding to each piece of dialogue pattern information. In a specific embodiment, the dialogue pattern information is a regular expression string of a dialogue, and the regular expression string of the dialogue may be transitioned based on a DFA algorithm to obtain a DFA structure diagram. Then the DFA structure diagram may be presented in the form of a DFA reachability matrix. FIG. 4 is a schematic diagram of the dialogue pattern state transition information, where the dialogue pattern state transition information is a two-dimensional array, and a column corresponding to st # represent state numbers. Characters include a, b, c, d, e, and EOF. When in state number 1 and an input character is a, a state to move to is 2, i.e., the state value corresponding to a row of the state number 1 and the column of the character a, the state is not 0, indicating that the character a has been successfully matched.

S306: Offset non-target information in the dialogue pattern state transition information respectively corresponding to the plurality of pieces of dialogue pattern information based on the target information in the dialogue pattern state transition information, to obtain offset dialogue pattern state transition information respectively corresponding to the plurality of pieces of dialogue pattern information. For example, for each of the plurality of pieces of dialogue pattern information, the non-target information in the dialogue pattern state transition information is shifted based on the target information in the dialogue pattern state transition information, to obtain offset dialogue pattern state transition information.

Specifically, the server offsets the non-target information in the dialogue pattern state transition information corresponding to each piece of dialogue pattern information based on the target information in the dialogue pattern state transition information, namely, a movement amount of the non-target information may be determined based on the position of the non-target information in the dialogue pattern state transition information and the position of the target information in the dialogue pattern state transition information, and then the offset is performed based on the movement amount. The dialogue pattern state transition information may be an adjacency matrix, and the non-target information in each row of the adjacency matrix is offset based on the target information in each previous row, such that the positions of the non-target information in each row after offset correspond to the positions of the target information in each previous row, thereby obtaining the offset dialogue pattern state transition information.

In a specific embodiment, FIG. 5 is a schematic diagram of offset dialogue pattern state transition information, where a column corresponding to off represents an offset amount. Starting from Row 0 and Row 1, each row is to be shifted until the values corresponding to the non-zero values in the current row in the rows above are zero values, and by traversing each row, the offset dialogue pattern state transition information is obtained.

S308: Perform compression based on the offset dialogue pattern state transition information to obtain pattern compression information respectively corresponding to the plurality of pieces of dialogue pattern information, and determine compression offset information respectively corresponding to the plurality of pieces of dialogue pattern information based on the offset of the non-target information in the dialogue pattern state transition information. For example, for each of the plurality of pieces of dialogue pattern information, compression is performed based on the offset dialogue pattern state transition information to obtain the pattern compression information, and the compression offset information is determined based on the offset of the shifted non-target information.

S310: Obtain the pattern description information respectively corresponding to the plurality of pieces of dialogue pattern information based on the pattern compression information and the compression offset information. For example, for each of the plurality of pieces of dialogue pattern information, the respective piece of pattern description information corresponding to the respective piece of dialogue pattern information is obtained based on the pattern compression information and the compression offset information.

Specifically, the server may then overwrite the target information in the offset dialogue pattern state transition information with the non-target information in the offset dialogue pattern state transition information, thereby obtaining the pattern compression information, and then determines the compression offset information corresponding to the dialogue pattern information based on the movement amount of the non-target information in the dialogue pattern state transition information. Finally, the server uses the pattern compression information and the compression offset information as the pattern description information corresponding to the dialogue pattern information, and saves the pattern description information to a data storage space to facilitate subsequent use.

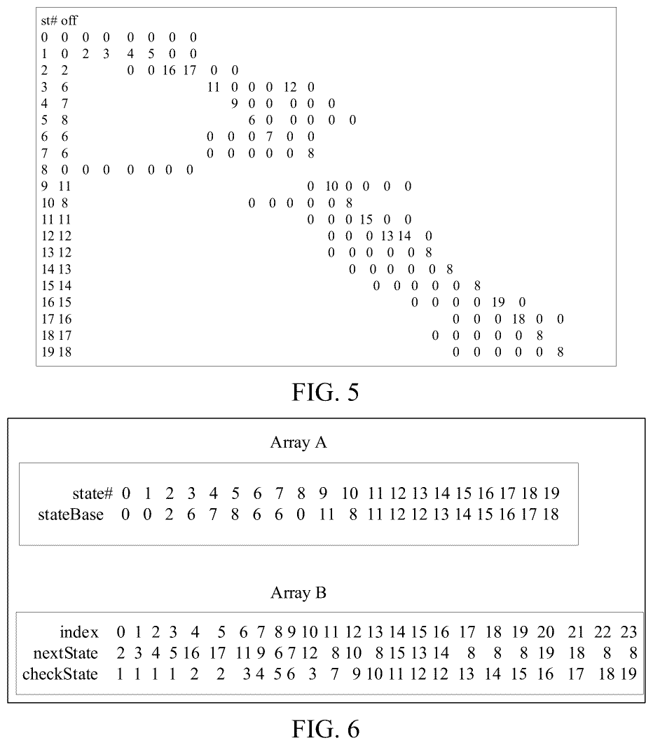

In a specific embodiment, FIG. 6 is a schematic diagram of pattern description information. An array A represents compression offset information. A first row in the compression offset information represents state numbers. The second row refers to an offset of a row corresponding to the state number. An array B represents pattern compression information. The first row in the pattern compression information represents indexes. The second row refers to the row obtained after overwriting all zero values with non-zero values, namely, each column has one non-zero value, and a one-dimensional array is configured for representing all non-zero values. The third row refers to a state number for characterizing a position of each non-zero value in the second row before compression.

In the foregoing embodiment, the state transition is performed on the dialogue pattern information to obtain the corresponding dialogue pattern state transition information, and then the non-target information in the dialogue pattern state transition information is offset based on the target information in the dialogue pattern state transition information, to obtain the offset dialogue pattern state transition information. Finally, the offset dialogue pattern state transition information is compressed, and corresponding compression offset information is obtained, thereby obtaining the pattern description information. To be specific, the dialogue pattern information is subjected to state transition and compression, thereby saving storage space, namely, reducing storage space resources occupied by the dialogue pattern information, further narrowing the matching search range, and thereby improving the efficiency of dialogue matching.

In an embodiment, S304 of respectively performing state transition on the plurality of pieces of dialogue pattern information corresponding to the dialogue service type through the DFA, to obtain dialogue pattern state transition information respectively corresponding to the plurality of pieces of dialogue pattern information includes operations:
obtaining current dialogue pattern information corresponding to the dialogue service type, and transitioning the current dialogue pattern information into a nondeterministic state connected graph, to obtain a current nondeterministic state connected graph; transitioning a current nondeterministic state connected graph into a deterministic state connected graph, to obtain the current deterministic state connected graph; and merging reused state nodes in the current deterministic state connected graph to obtain a target deterministic state connected graph, and obtaining dialogue pattern state transition information corresponding to the current dialogue pattern information based on the target deterministic state connected graph.

The current dialogue pattern information refers to the dialogue pattern information to be subjected to state transition currently. The current nondeterministic state connected graph refers to a nondeterministic state connected graph corresponding to current dialogue pattern information. The nondeterministic state connected graph refers to a connected graph in which each state and each input character may have a plurality of possible next states. To be specific, the nondeterministic state connected graph may be a nondeterministic finite automaton (NFC) diagram. The current deterministic state connected graph refers to a deterministic state connected graph corresponding to current dialogue pattern information. The deterministic state connected graph refers to a connected graph in which a definite next state may be transferred to through a transfer function for a state and an input character. The deterministic state connected graph may be a DFA diagram. The target deterministic state connected graph refers to a deterministic state connected graph obtained after a current deterministic state connected graph is minimized. A reused state node refers to an equivalent state node. The equivalent state node satisfies a consistency condition and a propagation condition. The consistency condition means that the two states need to be both accepting states or both non-accepting states simultaneously. The propagation condition requires that for all input characters, the two states need to transition to equivalent states.

Specifically, the server may select current dialogue pattern information successively from a plurality of pieces of dialogue pattern information. Then the current dialogue pattern information is first transitioned into a connected graph, and then the connected graph is transitioned into a nondeterministic state connected graph, thereby obtaining the current nondeterministic state connected graph. Then the current nondeterministic state connected graph is transitioned into a deterministic state connected graph through a transition algorithm, thereby obtaining the current deterministic state connected graph. The transition algorithm may be a subset construction algorithm. Then the reused state nodes satisfying the consistency condition and the propagation condition are screened out from the current deterministic state connected graph, and the reused state nodes in the current deterministic state connected graph are merged, thereby obtaining the target deterministic state connected graph. Finally, the dialogue pattern state transition information corresponding to the current dialogue pattern information is obtained based on the target deterministic state connected graph. In an embodiment, during a transition of the current nondeterministic state connected graph to a deterministic state connected graph to obtain the current deterministic state connected graph, the server may obtain a start state transition information record queue, record the information that needs to be traversed during the transition in the state transition information record queue, and perform the transition based on the state transition information record queue.

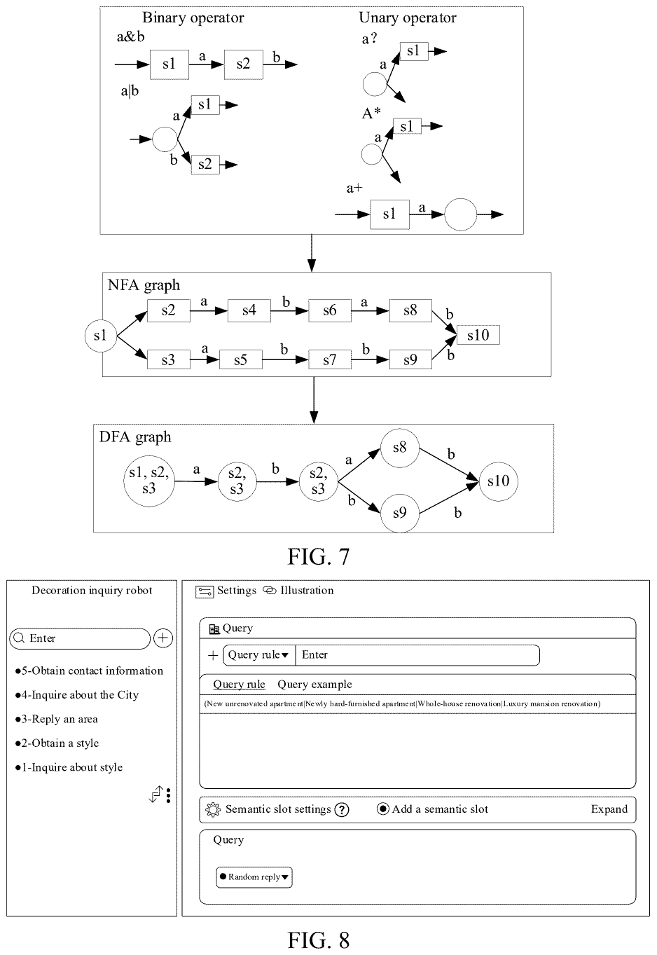

In a specific embodiment, the current dialogue pattern information is a regular expression ab, and state transition is performed on the regular expression ab to obtain dialogue pattern state transition information. FIG. 7 is a schematic diagram of obtained dialogue pattern state transition information. First, the regular expression ab is transitioned to a simple connected graph, including a connected graph corresponding to each unary operator and a connected graph corresponding to each binary operator. Then a simple connected graph is transitioned to an NFA graph, then the NFA graph is transitioned to a DFA graph, and finally the DFA graph is minimized. In other words, reused state nodes are merged to obtain a target DFA graph, and then an adjacency matrix in a storage form that corresponds to the target DFA graph is used as the dialogue pattern state transition information corresponding to the regular expression ab.

In the foregoing embodiment, the current nondeterministic state connected graph is obtained by transitioning the current dialogue pattern information into the nondeterministic state connected graph. Then the current nondeterministic state connected graph is transitioned into the deterministic state connected graph, to obtain the current deterministic state connected graph. The reused state nodes in the current deterministic state connected graph are merged to obtain a target deterministic state connected graph, and the dialogue pattern state transition information corresponding to the current dialogue pattern information is obtained based on the target deterministic state connected graph, thereby improving accuracy of the obtained dialogue pattern state transition information.

In an embodiment, after S310 of obtaining the pattern description information respectively corresponding to the plurality of pieces of dialogue pattern information based on the pattern compression information and the compression offset information, the method further includes operations:
performing a serialization operation on the pattern description information respectively corresponding to the plurality of pieces of dialogue pattern information, to obtain a serialized file, and storing the serialized file into a data management storage space; obtaining a dialogue matching instance establishment request, obtaining a serialized file from the data management storage space based on the dialogue matching instance establishment request, and performing a deserialization operation on the serialized file to obtain the pattern description information respectively corresponding to the plurality of pieces of dialogue pattern information; and loading the pattern description information respectively corresponding to the plurality of pieces of dialogue pattern information as a dialogue matching instance.

The serialization operation refers to a process of transitioning the pattern description information into a form that can be stored or transmitted. The serialized file refers to a file that stores the pattern description information obtained after the serialization operation is performed. The data management storage space is a storage space configured for data management. The storage space may be a database. The deserialization operation refers to a process of restoring a serialized file to pattern description information. The dialogue matching instance refers to pattern description information used when dialogue matching is performed. Each piece of pattern description information is a dialogue matching instance.

Specifically, the server may perform, through a data serialization tool, a serialization operation on pattern description information respectively corresponding to a plurality of pieces of dialogue pattern information, to obtain a serialized file. For example, the data serialization tool may be a protobuf (a structured data storage format) tool. The protobuf tool is configured to serialize structured data and then perform network transmission. The server may also perform a serialization operation on the pattern description information respectively corresponding to the plurality of pieces of dialogue pattern information through a data serialization interface, to obtain a serialized file. Then the serialized file is stored into the data management storage space. Then when detecting that a dialogue matching instance is to be loaded, the server obtains a dialogue matching instance establishment request, obtains the serialized file from the data management storage space based on the dialogue matching instance establishment request, performs deserialization on the serialized file, and unpacks the serialized file through the deserialization operation, thereby obtaining the pattern description information respectively corresponding to the plurality of pieces of dialogue pattern information. Finally, the server loads the pattern description information respectively corresponding to the plurality of pieces of dialogue pattern information as dialogue matching instances, for example, may perform the loading in a dialogue matching instance pool corresponding to the dialogue service type, and then use the instances during the matching. In some embodiments, the server may also directly save the pattern description information respectively corresponding to the plurality of pieces of dialogue pattern information. When the dialogue matching instance establishment request is obtained, the pattern description information respectively corresponding to the plurality of pieces of dialogue pattern information is directly loaded as the dialogue matching instance, so that transition operations can be reduced, and loading efficiency can be improved.

In a specific embodiment, the dialogue matching instance may be loaded through code shown below. The code is shown as follows:
func Buildmodel (skillInfo*model.SkilInfo) //for model compilation and data management service
func Loadmodel (array [ ]byte)*model. DFAData //load a decompressed DFA data model, generate DFA data needed for matching, and cache the DFA data
func PackDFADataProto (data*model. DFAData) //pack the DFA data model through Proto serialization
func UnPackDFADataProto(array [ ]byte)*model. DFAData)///unpack the DFA data model through Proto serialization

Operation S204 of obtaining the plurality of pieces of corresponding pattern description information based on the dialogue service type includes an operation:
obtaining, from the dialogue matching instance, the plurality of pieces of pattern description information corresponding to the dialogue service type.

Specifically, when performing pattern matching, the server obtains the plurality of pieces of corresponding pattern description information from a dialogue matching instance pool corresponding to a dialogue service type.

In the foregoing embodiments, the serialization operation is performed on the pattern description information respectively corresponding to the plurality of pieces of dialogue pattern information, to obtain a serialized file, and the serialized file is stored into a data management storage space. Then, through a deserialization operation, the pattern description information respectively corresponding to the plurality of pieces of dialogue pattern information is loaded as the dialogue matching instance, so that when performing pattern matching, the server may directly obtain the plurality of pieces of pattern description information from the loaded dialogue matching instance and perform matching, thereby improving matching efficiency.

In an embodiment, before S302 of obtaining the plurality of pieces of dialogue pattern information corresponding to the dialogue service type, the method further includes operations:
obtaining a dialogue service creation request, the dialogue service creation request carrying a dialogue service type; obtaining a corresponding dialogue service creation page based on the dialogue service type, and returning the dialogue service creation page to a requester side corresponding to the dialogue service creation request; obtaining a dialogue service release request that is triggered through the requester side corresponding to the dialogue service creation request through the dialogue service creation page; and parsing the dialogue service release request to obtain the plurality of pieces of dialogue pattern information corresponding to the dialogue service type and a dialogue configuration parameter corresponding to the dialogue service type, and storing, into a data management space, the plurality of pieces of dialogue pattern information corresponding to the dialogue service type and the dialogue configuration parameter corresponding to the dialogue service type.

The dialogue service creation request refers to a request for creating a dialogue service corresponding to a dialogue service type. The dialogue service creation page is a page for creation of a dialogue service. The plurality of pieces of dialogue pattern information and dialogue configuration parameters may be configured through the dialogue service creation page. The dialogue service release request refers to a request to release a created dialogue service. After the dialogue service is released, a dialogue may be made through the dialogue service.

Specifically, the server obtains a dialogue service creation request transmitted by a requester side, and parses the dialogue service creation request to obtain a carried dialogue service type. Then a corresponding dialogue service creation page is generated through the dialogue service type, and the dialogue service creation page is returned to the requester side corresponding to the dialogue service creation request. The requester side obtains and displays the dialogue service creation page. Then a creator may configure a dialogue service corresponding to the dialogue service type through the dialogue service creation page, and may configure the plurality of pieces of dialogue pattern information and the dialogue configuration parameters corresponding to the dialogue service type through the dialogue service creation page. When the configuration is completed, the server obtains the dialogue service release request that is triggered by the requester side corresponding to the dialogue service creation request through the dialogue service creation page. The server parses the dialogue service release request to obtain the plurality of pieces of dialogue pattern information corresponding to the dialogue service type and a dialogue configuration parameter corresponding to the dialogue service type, and stores, into a data management space, the plurality of pieces of dialogue pattern information corresponding to the dialogue service type and the dialogue configuration parameter corresponding to the dialogue service type. In some embodiments, the server may also transition the plurality of pieces of dialogue pattern information to corresponding pattern description information, and then serialize the plurality of pieces of pattern description information and store the serialized pattern description information into the data management space.

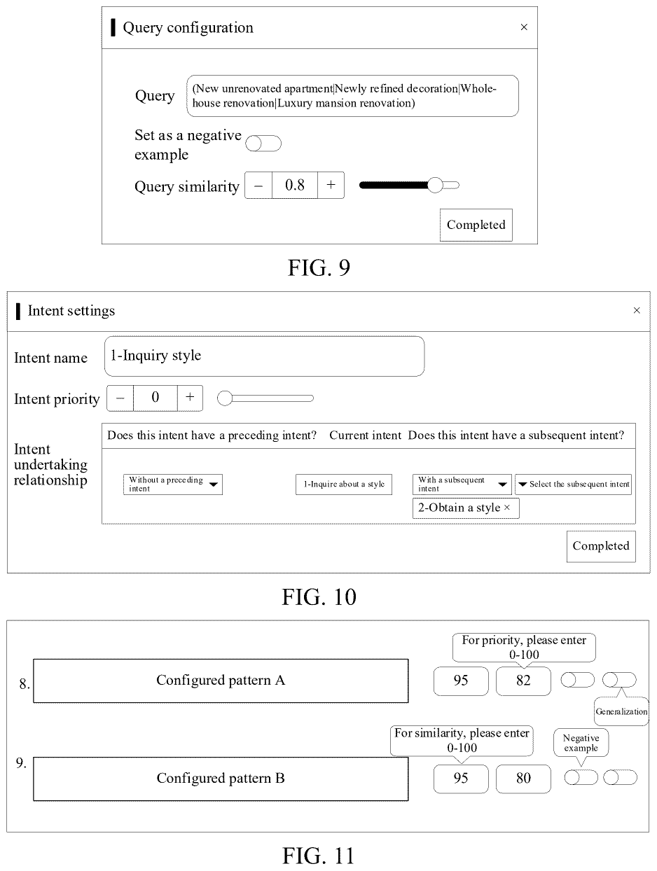

In a specific embodiment, a dialogue service robot may be created, and then the created dialogue service robot is released. Specifically, a dialogue service robot in a decoration industry is used as an example for description. FIG. 8 is a schematic diagram of a dialogue service creation page. A dialogue flow may be configured through a dialogue service creation page. For example, a dialogue intent of an inquiry style is configured. A plurality of pieces of dialogue pattern information may be configured through a query rule. A to-be-filled slot and a slot filling parameter are configured through a semantic slot setting, and then a reply corresponding to the dialogue intent of the corresponding inquiry style is configured through a reply. Then configuration parameters such as a similarity threshold for pattern generalization, a priority threshold for pattern hit, a slot heat threshold of patterns, a slot quantity threshold, and negative examples may be configured. For example, FIG. 9 is a schematic diagram of a query configuration page. A query similarity and whether it is a negative example are configured through the query configuration page. The query similarity refers to a similarity threshold between hit dialogue pattern information and the inquiry statement. If the similarity exceeds the threshold, it indicates that the matching with the hit pattern is successful. For example, FIG. 10 is a schematic diagram of an intent configuration page. Intent screening parameters such as an intent priority and an intent undertaking relationship are configured through the intent configuration page. The intent undertaking relationship refers to whether a current intent has a preceding intent, a succeeding intent, and the like.

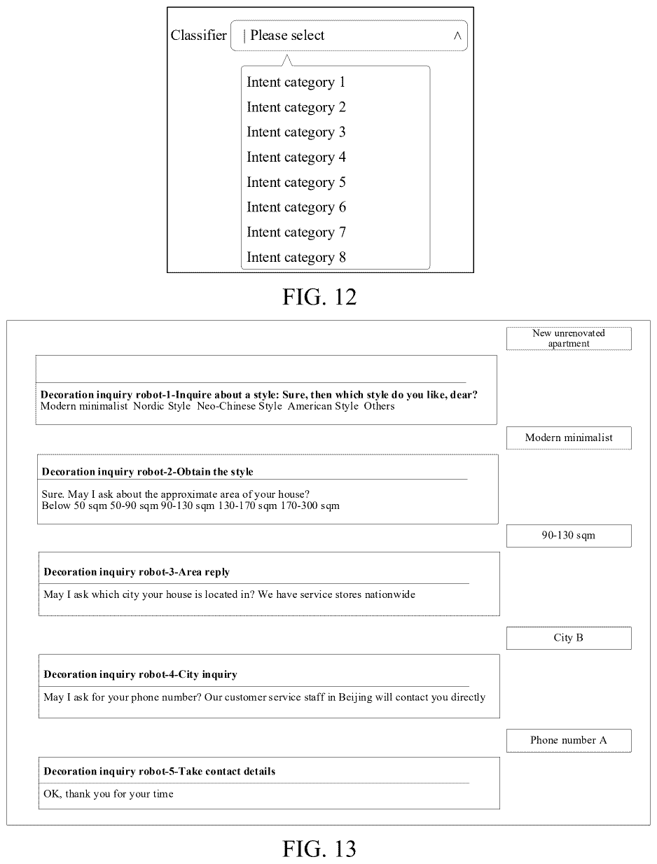

In a specific embodiment, FIG. 11 is a schematic diagram of another dialogue service creation page. Dialogue pattern information such as a pattern A and a pattern B may be directly configured through the dialogue service creation page, and then corresponding dialogue configuration parameters such as a similarity threshold, a priority value, whether to generalize, and whether it is a negative example may be configured. Configuration may further be performed to determine whether to call a model service, and an intent result of the model service may be configured. FIG. 12 is a schematic diagram of a classification model configuration page. Through the classification model configuration page, whether an intent classifier model is called may be configured, and an intent category for intent classification performed by an intent classifier model may be configured.

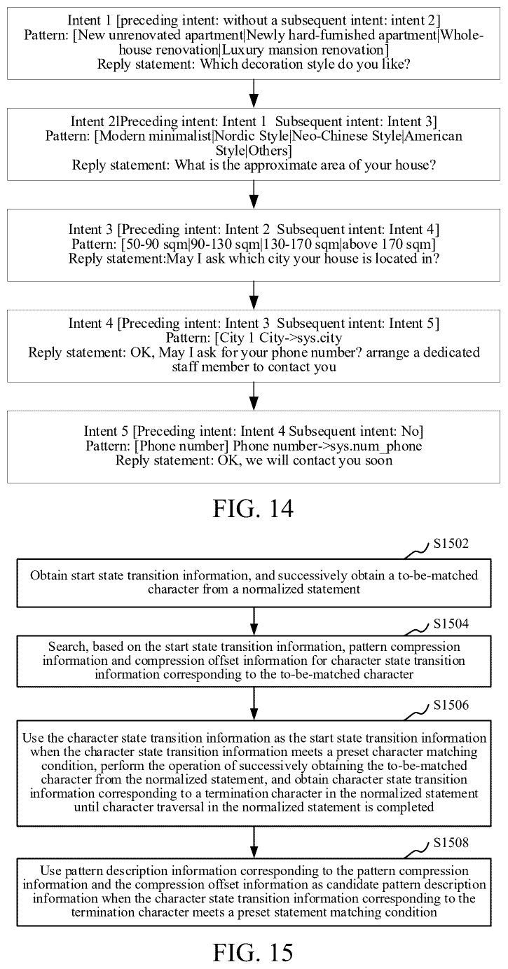

Then the dialogue service robot is released. A dialogue service in the decoration industry is provided through the dialogue service robot. FIG. 13 is a schematic diagram of a decoration service dialogue. When a server obtains an inquiry statement “new blank house” transmitted by the decoration inquiry robot, the server matches an intent of an inquiry style, and then obtains a reply statement corresponding to the intent of the inquiry style for reply, namely, displays the reply statement on the decoration dialogue page. The reply statement is a configured statement asking about the decoration style. When “modern minimalist” is selected, the server obtains an inquiry statement “modern minimalist”, matches an intent of the obtained style, then obtains a reply statement corresponding to the intent of the inquiry style for reply, and successively provides a dialogue service until no subsequent intent is obtained. In this case, the dialogue ends. FIG. 14 is a schematic diagram of a decoration service dialogue process on the decoration service dialogue page.

In the foregoing embodiments, a dialogue service creation request is obtained, the dialogue service creation request carrying a dialogue service type; a corresponding dialogue service creation page is obtained based on the dialogue service type, and the dialogue service creation page is returned to a requester side corresponding to the dialogue service creation request; a dialogue service release request that is triggered through the requester side corresponding to the dialogue service creation request through the dialogue service creation page is obtained; and the dialogue service release request is parsed to obtain the plurality of pieces of dialogue pattern information corresponding to the dialogue service type and a dialogue configuration parameter corresponding to the dialogue service type, and the plurality of pieces of dialogue pattern information corresponding to the dialogue service type and the dialogue configuration parameter corresponding to the dialogue service type are stored into a data management space. In other words, the dialogue configuration parameter and the plurality of pieces of dialogue pattern information are configured through a dialogue service creation page, so that flexible control over the matching process can be realized, thereby improving flexibility of a dialogue service.

In an embodiment, S206 of matching the inquiry statement with the plurality of pieces of pattern description information based on the pattern compression information and the compression offset information, to obtain a plurality of pieces of candidate pattern description information includes operations:
performing a normalization operation on the inquiry statement based on a normalized parameter in the dialogue configuration parameter, to obtain a normalized statement; and matching the normalized statement with the plurality of pieces of pattern description information based on the pattern compression information and the compression offset information, to obtain the plurality of pieces of candidate pattern description information.

The normalized parameter refers to a pre-configured parameter for performing the normalization operation on the inquiry statement, where the normalization operation may include error correction, rewriting, symbol processing, or the like.

Specifically, the server performs the normalization operation on the inquiry statement based on the normalized parameter in the dialogue configuration parameter. For example, the same symbol in the inquiry statement is removed based on a pre-configured symbol that needs to be removed, and rewriting and error correction are performed on the inquiry statement. The rewriting and error correction may be performed on the inquiry statement by calling a rewriting and error correction algorithm. The rewriting and error correction algorithm may be a rewriting and error correction model or the like established through a neural network algorithm, to obtain a normalized statement. Then, the normalized statement is matched with the plurality of pieces of pattern description information based on pattern compression information and compression offset information, to obtain the plurality of pieces of candidate pattern description information.

In the foregoing embodiment, the normalization operation is performed on the inquiry statement based on the normalized parameter in the dialogue configuration parameter, to obtain a normalized statement. Finally, the normalized statement is matched with the plurality of pieces of pattern description information based on the pattern compression information and the compression offset information, to obtain the plurality of pieces of candidate pattern description information, so as to avoid using non-standard statements for matching, thereby improving matching accuracy.

In an embodiment, as shown in FIG. 15, the matching the normalized statement with the plurality of pieces of pattern description information based on the pattern compression information and the compression offset information, to obtain a plurality of pieces of candidate pattern description information includes the following operations.

S1502: Obtain start state transition information, and successively obtain a to-be-matched character from the normalized statement.

The start state transition information refers to pre-configured state transition information used when the matching starts to be performed. The start state transition information may be set as non-target information, which may be for example 1. The to-be-matched character refers to a character that needs to be matched, and is a character in the normalized statement. The to-be-matched character may be a start character in the normalized statement, or may be any character.

Specifically, the server obtains pre-configured start state transition information, and then successively obtains a to-be-matched character from characters in the normalized statement. To be specific, the characters are successively used as the to-be-matched characters. When the matching starts, the to-be-matched character is the start character in the normalized statement.

S1504: Search, based on the start state transition information, the pattern compression information and the compression offset information for character state transition information corresponding to the to-be-matched character.

The character state transition information refers to state transition information found through the to-be-matched character.

Specifically, the server searches the pattern compression information and the compression offset information for the character state transition information corresponding to the to-be-matched character based on start state transition information. Offset information corresponding to the to-be-matched character is determined through the start state transition information and the compression offset information, and the pattern compression information is searched for the character state transition information corresponding to the to-be-matched character based on the offset information.

S1506: Use the character state transition information as the start state transition information when the character state transition information meets a preset character matching condition, perform the operation of successively obtaining the to-be-matched character from the normalized statement, and obtain character state transition information corresponding to a termination character in the normalized statement until character traversal in the normalized statement is completed.

The preset character matching condition refers to a pre-configured condition for successful character matching. For example, the preset character matching condition may be that state transition information is non-target information. The termination character is the last character in the normalized statement.

Specifically, the server determines whether the character state transition information conforms to the preset character matching condition. When the character state transition information does not meet the preset character matching condition, it indicates that the inquiry statement does not match the dialogue pattern information. In this case, the inquiry statement is matched with the dialogue pattern description information corresponding to next dialogue pattern information. When the character state transition information conforms to the preset character matching condition, it indicates that the character has been successfully matched. In this case, the server uses the character state transition information as the start state transition information, performs the operation of successively obtaining the to-be-matched character from the normalized statement, and obtains character state transition information corresponding to the termination character in the normalized statement until character traversal in the normalized statement is completed.

S1508: Use pattern description information corresponding to the pattern compression information and the compression offset information as the candidate pattern description information when the character state transition information corresponding to the termination character meets a preset statement matching condition.

The preset statement matching condition refers to a pre-configured condition for successful statement matching. The preset statement matching condition may be that character state transition information corresponding to the termination character is non-target information, namely, in a receiving state.

Specifically, the server determines whether the character state transition information corresponding to the termination character conforms to the preset statement matching condition. When the character state transition information corresponding to the termination character does not meet the preset statement matching condition, it indicates that the inquiry statement fails to match the dialogue pattern information. When the character state transition information corresponding to the termination character meets a preset statement matching condition, the pattern description information corresponding to the pattern compression information and the compression offset information are used as the candidate pattern description information.

In some examples, in view of the example in FIG. 15, the matching the normalized statement with each of the plurality of pieces of pattern description information includes, for each of the plurality of pieces of pattern description information, obtaining start state transition information, performing a first iteration, and/or performing one or more additional iterations based on various factors. For example, the first iteration may include obtaining a to-be-matched character for the first iteration that is a first character of the normalized statement; and searching, based on the start state transition information, the pattern compression information and the compression offset information for character state transition information corresponding to the to-be-matched character for the first iteration. In some examples, one or more additional iterations may be performed when the character state transition information from a previous iteration meets a character matching condition. For example, each iteration of the one or more additional iterations includes obtaining to-be-matched character for the respective iteration from the normalized statement next to a previous to-be-matched character for the previous iteration; and searching, based on the character state transition information from the previous iteration as start state transition information for the respective iteration, the pattern compression information and the compression offset information for character state transition information corresponding to the to-be-matched character for the respective iteration. In some examples, when last character state transition information from last iteration based on a last character of the normalized statement meets a statement matching condition, the respective piece of the plurality of pieces of pattern description information may be determined as one of the one or more pieces of candidate pattern description information.

In a specific embodiment, the server may further obtain a matching parameter. The matching parameter is configured for characterizing whether complete matching or partial matching is adopted, and then match the normalized statement with the plurality of pieces of pattern description information through the pattern compression information and the compression offset information based on the matching parameter, to obtain the plurality of pieces of candidate pattern description information. The partial matching may include prefix matching, suffix matching, and the like.

In the foregoing embodiment, the pattern compression information and the compression offset information are searched for character state transition information corresponding to the to-be-matched character through the start state transition information. When the character state transition information meets a preset character matching condition, the character state transition information is used as the start state transition information, the operation of successively obtaining the to-be-matched character from the normalized statement is performed, and character state transition information corresponding to a termination character in the normalized statement is obtained until character traversal in the normalized statement is completed. When the character state transition information corresponding to the termination character meets the preset statement matching condition, the pattern description information corresponding to the pattern compression information and the compression offset information is used as the candidate pattern description information. To be specific, matching is successively performed based on the characters to determine the candidate pattern description information, thereby improving accuracy of obtaining the candidate pattern description information. In addition, the matching is performed based on the pattern compression information and the compression offset information, thereby narrowing a search range, and improving matching efficiency.

In an embodiment, the pattern compression information includes compression state transition information and detection state transition information corresponding to the compression state transition information.

S1504 of searching, based on the start state transition information, the pattern compression information and the compression offset information for character state transition information corresponding to the to-be-matched character includes operations:
searching the compression offset information for start offset information corresponding to the start state transition information, and searching the detection state transition information for corresponding character detection state transition information based on the start offset information and the to-be-matched character; and searching the compression state transition information for corresponding character state transition information based on the start offset information and the to-be-matched character when the character detection state transition information is consistent with the start state transition information.

The compression state transition information refers to the compressed state transition information, which is state transition information stored through a one-dimensional array and represents next state transition information corresponding to a character. The detection state transition information refers to state transition information configured for detection, and is a state number corresponding to the character before compression. The start offset information refers to offset information corresponding to the start state transition information, which may be an offset amount. The start offset information corresponding to the start state transition information may be searched based on a correspondence between the state transition information and the offset information. The character detection state transition information refers to detection state transition information corresponding to a to-be-matched character.

Specifically, the server may search the compression offset information for the start offset information corresponding to the start state transition information based on the correspondence between the state transition information and the offset information. To be specific, the compression offset information includes the correspondence between the state transition information and the offset information. Then the server searches the detection state transition information for the corresponding character detection state transition information through the start offset information and the to-be-matched character, and then determines whether the character detection state transition information is consistent with the start state transition information. When the character detection state transition information is not consistent with the start state transition information, it indicates that the to-be-matched character is not successfully matched. In this case, prompt information indicating that the match was unsuccessful is returned. When the character detection state transition information is consistent with the start state transition information, the to-be-matched character is successfully matched. In this case, the server searches the compression state transition information for the corresponding character state transition information through the start offset information and the to-be-matched character, where the corresponding character state transition information may be searched based on the start offset information, and a correspondence between the to-be-matched character and next state transition information.

In a specific embodiment, a quick recall, namely, a search for the character state transition information corresponding to the to-be-matched character, may be performed through the code shown below.

```
//DFA rapid call
if (checkState[Statebase[s]+i] = = s){
  return nextState[Statebase[s]+i];
} else {
  return 0;
}
```

where s characterizes state transition information, which may be a state number. i characterizes an input character, which may be a character number. Statebase[s] refers to start offset information. checkState[Statebase[s]+i] is configured for characterizing character detection state transition information. nextState[Statebase[s]+i] is configured for characterizing character state transition information. 0 represents that the match is unsuccessful.

In the foregoing embodiment, when the character detection state transition information is consistent with the start state transition information, the compression state transition information is searched for the corresponding character state transition information. In other words, the efficiency of finding character state transition information is improved while ensuring the accuracy of the search.

In an embodiment, S208 of performing slot filling on the dialogue pattern information respectively corresponding to the plurality of pieces of candidate pattern description information based on a slot filling parameter in the dialogue configuration parameter, to obtain a plurality of pieces of dialogue intent information includes operations:
determining a preset filling identifier in the dialogue pattern information, and obtaining a plurality of pieces of to-be-filled information corresponding to the preset filling identifier; screening the plurality of pieces of to-be-filled information based on the slot filling parameter in the dialogue configuration parameter, to obtain target to-be-filled information corresponding to the preset filling identifier; and performing slot filling on the target to-be-filled information in the dialogue pattern information, to obtain dialogue intent information corresponding to the dialogue pattern information.

The preset filling identifier refers to a pre-configured identifier on which the slot filling needs to be performed, and different slots may have different preset filling identifiers. The to-be-filled information refers to pre-configured information that can be filled into the corresponding slots, which may be character strings, such as words and phrases. The target to-be-filled information refers to the to-be-filled information obtained through screening of the plurality of pieces of to-be-filled information. The slot filling parameter refers to a pre-configured control parameter during the slot filling.

Specifically, when the dialogue pattern information is configured, a preset filling identifier may be configured in the dialogue pattern information. During the slot filling, the server may determine, from the dialogue pattern information, a preset filling identifier on which the slot filling needs to be performed. The plurality of pieces of to-be-filled information corresponding to the preset filling identifier are obtained from a database. For example, a pre-configured dictionary may be searched for a dictionary result corresponding to the preset filling identifier, to obtain a plurality of to-be-filled words. The plurality of pieces of to-be-filled information are screened based on the slot filling parameter in the dialogue configuration parameter. For example, the slot filling parameter may prioritize popularity values, and then to-be-filled information with a maximum popularity value is selected based on the popularity values of the plurality of pieces of to-be-filled information, to obtain the target to-be-filled information. The slot filling parameter may prioritize integrity, and then to-be-filled information with highest integrity is selected based on the integrity corresponding to the plurality of pieces of to-be-filled information, to obtain the target to-be-filled information. The slot filling parameter may prioritize similarities, and then to-be-filled information with a highest similarity is selected based on the similarities corresponding to the plurality of pieces of to-be-filled information. The similarity refers to a similarity between a dialogue intent information obtained by performing slot filling on the to-be-filled information and an inquiry statement. The similarity may be calculated through a similarity algorithm. Finally, the server performs slot filling on the target to-be-filled information in the dialogue pattern information, to obtain dialogue intent information corresponding to the dialogue pattern information.

In a specific embodiment, during the slot filling phase, the server controls the slot filling process by using parameters such as a pattern information similarity, a pattern information similarity threshold, a slot popularity, a slot popularity threshold, and a quantity of slots, as well as information such as a slot matching priority and dictionary connectivity, and then calls a similarity service to calculate the similarity to complete the processes of slot assignment, verification, and filling, thereby obtaining the dialogue intent information corresponding to the dialogue pattern information. For the same dialogue pattern information, different dialogue intent information is obtained through different slot filling parameters. For example, a plurality of to-be-filled song names and singer names may be obtained from a dictionary based on song slots. Then the song name and the singer name with the highest similarity may be preferentially selected based on the pattern information similarity, or the song name and the singer name with the highest popularity may be preferentially selected based on the slot popularity, or the song name and the singer name exceeding the threshold may be selected based on the similarity threshold, or the song name and the singer name may be selected based on the dictionary matching priority and the dictionary connectivity, or the song name and the singer name may be selected based on the quantity of slots. The server may also select dialogue intent information by combining a plurality of pieces of parameter information, for example, select a song name and a singer name that exceed a threshold by using the similarity threshold and the slot popularity threshold.

In the foregoing embodiment, the plurality of pieces of to-be-filled information are screened based on the slot filling parameter in the dialogue configuration parameter, to obtain the target to-be-filled information corresponding to the preset filling identifier. Then slot filling is performed on the target to-be-filled information in the dialogue pattern information to obtain the dialogue intent information corresponding to the dialogue pattern information, so that the slot filling is controlled through the slot filling parameter, thereby improving flexibility of the slot filling.

In an embodiment, S208 of screening the plurality of pieces of dialogue intent information based on an intent screening parameter in the dialogue configuration parameter, to obtain target dialogue intent information includes operations:
ranking the plurality of pieces of dialogue intent information based on a pattern priority parameter in the dialogue configuration parameter, to obtain a dialogue intent information sequence; and selecting, from the dialogue intent information sequence, dialogue intent information ranked first, to obtain the target dialogue intent information.

The pattern priority parameter is configured for characterizing a priority of the dialogue pattern information. Different dialogue pattern information has different pattern priority parameters which are preset.

Specifically, the plurality of pieces of dialogue intent information are ranked based on the pattern priority parameter in the dialogue configuration parameter, which may mean that the plurality of pieces of dialogue intent information are ranked in descending order based on priority scores of dialogue pattern information corresponding to each piece of dialogue intent information, to obtain a dialogue intent information sequence, and then dialogue intent information ranked first is selected from the dialogue intent information sequence to obtain the target dialogue intent information. In other words, dialogue intent information with a highest priority score is selected as the target dialogue intent information. In some embodiments, the server may also successively select at least two pieces of dialogue intent information from the dialogue intent information sequence in descending order of priority scores, use each of the at least two pieces of dialogue intent information as target dialogue intent information, then obtain target reply statements associated with each target dialogue intent information, and finally return all of the target reply statements to the requester side corresponding to the dialogue request.

In the foregoing embodiment, the plurality of pieces of dialogue intent information are ranked based on the pattern priority parameter in the dialogue configuration parameter, to obtain the dialogue intent information sequence. Then the dialogue intent information ranked first is selected from the dialogue intent information sequence, to obtain the target dialogue intent information, so that the pattern priority parameter can be used to control and screen the dialogue intent information, thereby improving matching flexibility.

In an embodiment, S210 of obtaining a reply statement associated with the target dialogue intent information, and returning the reply statement to the requester side corresponding to the dialogue request includes operations:
calling a model classification service and a model matching service based on a model service parameter in the dialogue configuration parameter; performing intent classification on the inquiry statement based on the model classification service, to obtain classification intent information corresponding to the inquiry statement; performing intent matching on the inquiry statement based on the model matching service, to obtain matching intent information corresponding to the inquiry statement; merging the target dialogue intent information, the classification intent information, and the matching intent information to obtain final intent information; and obtaining a target reply statement associated with the final intent information, and returning the target reply statement to the requester side corresponding to the dialogue request.

The model classification service refers to a service for invoking an intent classification and recognition neural network model to perform intent classification and recognition on an inquiry statement. The classification intent information refers to intent information corresponding to the inquiry statement obtained by the invoked intent classification and recognition neural network model through classification and recognition. The model matching service refers to a service that invokes an intent matching neural network model to perform intent matching on an inquiry statement. The matching intent information refers to intent information corresponding to the inquiry statement obtained by the invoked intent matching neural network model through matching. The final intent information refers to the intent information corresponding to the inquiry statement for which the final matching tie is broken. The model service parameter refers to a parameter for calling a model service, which may be a calling interface of a model, or the like.

Specifically, the server concurrently calls a model classification service and a model matching service based on the model service parameter in the dialogue configuration parameter. Then the server performs intent classification on the inquiry statement based on the model classification service, to obtain classification intent information corresponding to the inquiry statement. In other words, the server may call an intent classification and recognition neural network model through a model classification service interface to perform intent classification and recognition on the inquiry statement, to obtain classification intent information outputted by the model. The outputted classification intent information may include a plurality of pieces of classification intent information. The intent classification and recognition neural network model is a model trained through a neural network algorithm in advance. Then the server performs intent matching on the inquiry statement through the model matching service, to obtain matching intent information corresponding to the inquiry statement. In other words, the server may call an intent matching neural network model through a model matching service interface to perform intent matching on the inquiry statement, to obtain matching intent information outputted by the model. The outputted matching intent information may include a plurality of pieces of matching intent information. Finally, the server aggregates and merges the target dialogue intent information, the classification intent information, and the matching intent information to obtain final intent information. Finally, the server obtains a target reply statement associated with the final intent information, and returns the target reply statement to the requester side corresponding to the dialogue request.

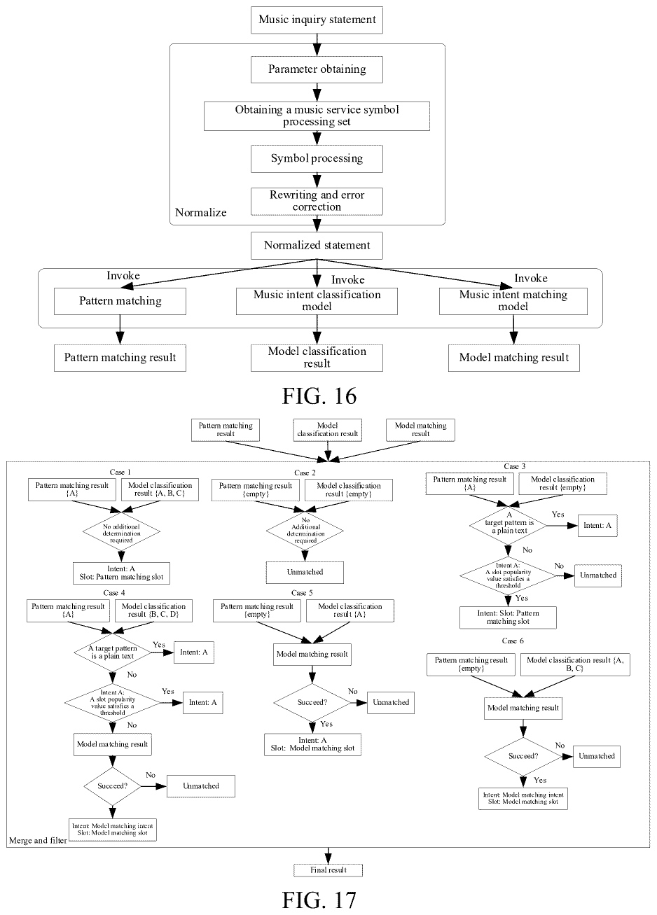

In a specific embodiment, FIG. 16 provides a schematic diagram of music dialogue matching. Specifically, a server obtains a music inquiry statement transmitted by a music dialogue service robot, and then obtains a dialogue configuration parameter based on a music dialogue service. The dialogue configuration parameter may include DFA matching parameters such as prefix and suffix matching and complete matching, or may include a normalized parameter, and may further include an algorithm component pool parameter, and the like. The music inquiry statement may be normalized through the normalized parameter. During the normalization, a music service symbol processing set may be obtained, which may include a to-be-removed symbol set such as (~, !, @, #, :, ″, @, #, ¥, . . . ), a to-be-escaped symbol set such as (%, =, +, < >, /, %, =, *, . . . ), and another symbol set (π, γ, α, . . . ). Then a symbol in the music inquiry statement is processed based on the music service symbol processing set. Then rewriting and error correction is performed on the music inquiry statement subjected to symbol processing based on an invoked statement rewriting and error correction service model of the music dialogue service, thereby obtaining a normalized result, namely, a normalized statement. Then pattern matching is performed through the normalized statement. To be specific, matching is performed with a plurality of pieces of pattern description information, to obtain a pattern matching result, namely, target dialogue intent information. In addition, a music intent classification model is invoked from an algorithm component pool through the algorithm component pool parameter to perform intent classification on the normalized statement, to obtain a model classification result. The model classification result may include a plurality of pieces of classification intent information. Moreover, a music intent matching model is invoked from the algorithm component pool through the algorithm component pool parameter to perform matching on the normalized statement, to obtain a model matching result. The model matching result may include a filling result of a slot in the dialogue pattern information. Finally, the pattern matching result, the model classification result, and the model matching result are summarized to obtain final music inquiry intent information, and a music reply statement associated with the final music inquiry intent information is returned to the requester side corresponding to the dialogue request.

In the foregoing embodiment, intent classification is performed on the inquiry statement through the model classification service, to obtain the classification intent information corresponding to the inquiry statement, and then intent matching is performed on the inquiry statement through the model matching service, to obtain the matching intent information corresponding to the inquiry statement. Finally, the target dialogue intent information, the classification intent information, and the matching intent information are merged to obtain the final intent information, thereby improving accuracy of the obtained final intent information. Finally, the target reply statement associated with the final intent information is obtained. The target reply statement is returned to the requester side corresponding to the dialogue request, thereby improving accuracy of dialogue matching.

In an embodiment, the merging the target dialogue intent information, the classification intent information, and the matching intent information to obtain final intent information includes operations:
using the target dialogue intent information as the final intent information when the target dialogue intent information is consistent with the classification intent information; screening out, from the target dialogue intent information and the classification intent information, intent information that meets a preset intent condition when the target dialogue intent information is not consistent with the classification intent information; using, as the final intent information when the intent information meeting the preset intent condition exists, the intent information meeting the preset intent condition; and using the matching intent information as the final intent information when no intent information meeting the preset intent condition exists.

The preset intent condition refers to a pre-configured parameter condition for intent screening. For example, the preset intent condition may be a slot popularity value threshold of intent information, or the preset intent condition may be the intent information, a plain text, or the like.

Specifically, the server determines whether the target dialogue intent information is consistent with the classification intent information. When the target dialogue intent information is consistent with the classification intent information, the server may use the target dialogue intent information as the final intent information. When a plurality of pieces of classification intent information are obtained, the server may compare the target dialogue intent information with the plurality of pieces of classification intent information, and use the target dialogue intent information as the final intent information when intent information consistent with the target dialogue intent information exists in the plurality of pieces of classification intent information. When no intent information consistent with the target dialogue intent information exists in the plurality of pieces of classification intent information, it indicates that the target dialogue intent information is not consistent with the classification intent information. In this case, the server screens the target dialogue intent information and the classification intent information for the intent information that meets the preset intent condition. When determining that when the intent information meeting the preset intent condition exists, the server uses, as the final intent information, the intent information that meets the preset intent condition. When determining that when no intent information meeting the preset intent condition exists, the server uses the matching intent information as the final intent information.

In a specific embodiment, FIG. 17 provides a schematic diagram of obtaining final intent information. Specifically, a server merges target dialogue intent information, classification intent information, and matching intent information. For a pattern matching result, 0 to 1 piece of intent information is usually obtained. For a model classification result, 0 to n (a positive integer) pieces of intent information are usually obtained. For a model matching result, 0 to m (a positive integer) slot filling results are usually obtained. In Case 1, intent information obtained from the pattern matching result is A, and intent information obtained from the model classification result includes A, B, and C. Since consistent intent information exists between the pattern matching result and the model classification result, the server does not need to perform additional determination, and directly uses, as a final matching result, the intent information A obtained from the pattern matching result and a slot obtained from the model matching result. In Case 2, if the pattern matching result is empty, namely, no corresponding intent information is matched, and the model classification result is also empty. In this case, the server does not need to perform additional determination, and directly uses “unmatched” as the final matching result. In Case 3, the intent information obtained for the pattern matching result is A, and the model classification result is empty. In this case, it is determined whether target dialogue pattern information corresponding to the intent information A is the plain text. When the target dialogue pattern information is the plain text, the intent information A obtained from the pattern matching result and the slot obtained from the model matching result are used as the final matching result. When the target dialogue pattern information is not the plain text, it is determined whether a slot popularity value of the intent information A satisfies a threshold. When the threshold is not satisfied, “unmatched” is used as the final matching result. When the threshold is satisfied, the intent information A obtained from the pattern matching result and the slot obtained from the model matching result are used as the final matching result. In Case 4, intent information obtained from the pattern matching result is A, and intent information obtained from the model classification result includes B, C, and D. In this case, it is determined whether target dialogue pattern information corresponding to the intent information A is the plain text. When the target dialogue pattern information is the plain text, the intent information A obtained from the pattern matching result and the slot obtained from the model matching result are used as the final matching result. When the target dialogue pattern information is not the plain text, it is determined whether a slot popularity value of the intent information A satisfies a threshold. When the threshold is satisfied, the intent information A obtained from the pattern matching result and the slot obtained from the model matching result are used as the final matching result. When the threshold is not satisfied, a model matching result is obtained. When the model matching result is successful, the intent information included in the model matching result and the slot filling information are used as the final matching result. When the model matching result is unsuccessful, “unmatched” is used as the final matching result. In Case 5, a pattern matching result is empty, and intent information obtained from the model classification result is A. In this case, the server obtains a model matching result, and then when the model matching result is successful, uses, as the final matching result, the intent information A obtained through model classification and the slot filling information obtained through model matching. When the model matching result is unsuccessful, “unmatched” is used as the final matching result. In Case 6, a pattern matching result is empty, and intent information obtained from the model classification result is A, B, and C. In this case, a model matching result is obtained, and when the model matching result is unsuccessful, “unmatched” is used as the final matching result. When the model matching result is successful, the intent information obtained through model matching and the slot filling information obtained through model matching are used as the final matching result.

In the foregoing embodiment, the target dialogue intent information is used as the final intent information when the target dialogue intent information is consistent with the classification intent information; intent information that meets a preset intent condition is screened out from the target dialogue intent information and the classification intent information when the target dialogue intent information is not consistent with the classification intent information; the intent information meeting the preset intent condition is used as the final intent information when the intent information meeting the preset intent condition exists; and the matching intent information is used as the final intent information when no intent information meeting the preset intent condition exists. To be specific, the final intent information is determined through consistency comparison and the preset intent condition, thereby improving the accuracy of the obtained final intent information.

In some examples, in view of the dialogue processing method described in this disclosure, the dialogue request may be a dialogue request transmitted through a music dialogue page. In some examples, the inquiry statement may be a music inquiry statement, the dialogue service type may be a music dialogue service type, the reply statement may be a music reply statement, and the outputting the reply statement may include displaying the music reply statement on the music dialogue page.

In an embodiment, the dialogue method includes operations:
obtaining a dialogue request transmitted through a music dialogue page, the dialogue request carrying a music inquiry statement; obtaining a music dialogue service type based on the dialogue request, and obtaining a corresponding music dialogue configuration parameter and a plurality of pieces of music pattern description information based on the music dialogue service type, the music pattern description information including music pattern compression information and music compression offset information, the music pattern compression information being obtained by performing state transition on music dialogue pattern information to obtain music dialogue pattern state transition information and compressing target information in the music dialogue pattern state transition information, and the music compression offset information being configured for characterizing an offset of non-target information in the music dialogue pattern state transition information; and matching the music inquiry statement with the plurality of pieces of music pattern description information based on the music pattern compression information and the music compression offset information, to obtain a plurality of pieces of candidate music pattern description information; performing slot filling on the dialogue pattern information respectively corresponding to the plurality of pieces of candidate music pattern description information based on a slot filling parameter in the music dialogue configuration parameter, to obtain a plurality of pieces of music dialogue intent information, and screening the plurality of pieces of music dialogue intent information based on an intent screening parameter in the music dialogue configuration parameter, to obtain target music dialogue intent information; and obtaining a music reply statement associated with the target music dialogue intent information, and displaying the music reply statement on the music dialogue page.

The music dialogue page refers to a page that provides a music dialogue service, and the music dialogue service may be implemented through a released music dialogue robot.

Specifically, the dialogue method is applied to a scenario of the music dialogue service. In the scenario of the music dialogue service, the server may provide the music dialogue service through the dialogue method in any one of the foregoing embodiments, and may ask a music-related question through the music dialogue service, such as inquiring about a singer of Song A. To be specific, the server obtains, through the music inquiry statement transmitted from the music dialogue page, the music dialogue configuration parameter and a plurality of pieces of music pattern description information that correspond to the music dialogue service type. Then the music inquiry statement is matched with the plurality of pieces of music pattern description information through the music pattern compression information and the music compression offset information, and slot filling and intent screening are performed, to obtain target music dialogue intent information corresponding to the music inquiry statement, and then a music reply statement associated with the target music dialogue intent information is transmitted to the music dialogue page for display.

In the foregoing embodiment, the music dialogue configuration parameter and the plurality of pieces of music pattern description information corresponding to the music dialogue service type are obtained, and then the music inquiry statement is matched with the plurality of pieces of music pattern description information through the music pattern compression information and the music compression offset information, thereby improving matching efficiency of a music dialogue service. Then a music reply statement associated with the target music dialogue intent information is transmitted to a music dialogue page for display, thereby improving efficiency of a music dialogue.

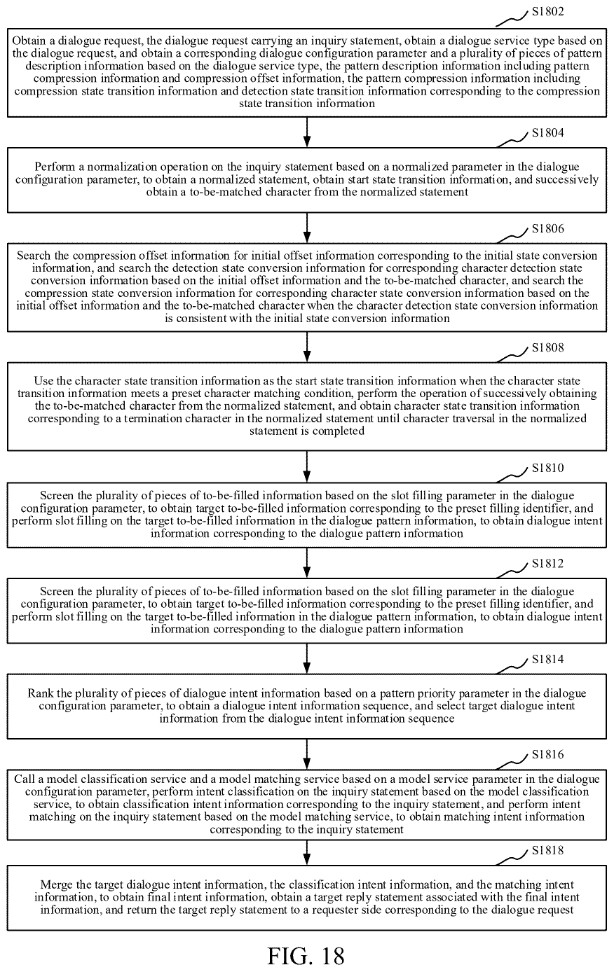

In a specific embodiment, FIG. 18 is a schematic flowchart of a dialogue method, specifically including the following operations.

S1802: Obtain a dialogue request, the dialogue request carrying an inquiry statement, obtain a dialogue service type based on the dialogue request, and obtain a corresponding dialogue configuration parameter and a plurality of pieces of pattern description information based on the dialogue service type, the pattern description information including pattern compression information and compression offset information, the pattern compression information including compression state transition information and detection state transition information corresponding to the compression state transition information.

S1804: Perform a normalization operation on the inquiry statement based on a normalized parameter in the dialogue configuration parameter, to obtain a normalized statement, obtain start state transition information, and successively obtain a to-be-matched character from the normalized statement.

S1806: Search the compression offset information for start offset information corresponding to the start state transition information, search the detection state transition information for corresponding character detection state transition information based on the start offset information and the to-be-matched character, and search the compression state transition information for corresponding character state transition information based on the start offset information and the to-be-matched character when the character detection state transition information is consistent with the start state transition information.

S1810: Use the character state transition information as the start state transition information when the character state transition information meets a preset character matching condition, perform the operation of successively obtaining the to-be-matched character from the normalized statement, and obtain character state transition information corresponding to a termination character in the normalized statement until character traversal in the normalized statement is completed.

S1812: Use pattern description information corresponding to the pattern compression information and the compression offset information as candidate pattern description information when the character state transition information corresponding to the termination character meets a preset statement matching condition, determine a preset filling identifier from a dialogue pattern information corresponding to the candidate pattern description information, and obtain a plurality of pieces of to-be-filled information corresponding to the preset filling identifier.

S1814: Screen the plurality of pieces of to-be-filled information based on the slot filling parameter in the dialogue configuration parameter, to obtain target to-be-filled information corresponding to the preset filling identifier, and perform slot filling on the target to-be-filled information in the dialogue pattern information, to obtain dialogue intent information corresponding to the dialogue pattern information.

S1816: Rank the plurality of pieces of dialogue intent information based on a pattern priority parameter in the dialogue configuration parameter, to obtain a dialogue intent information sequence, and select, from the dialogue intent information sequence, dialogue intent information ranked first, to obtain the target dialogue intent information.

S1817: Call a model classification service and a model matching service based on a model service parameter in the dialogue configuration parameter, perform intent classification on the inquiry statement based on the model classification service, to obtain classification intent information corresponding to the inquiry statement, and perform intent matching on the inquiry statement based on the model matching service, to obtain matching intent information corresponding to the inquiry statement.

S1818: Merge the target dialogue intent information, the classification intent information, and the matching intent information, to obtain final intent information, obtain a target reply statement associated with the final intent information, and return the target reply statement to a requester side corresponding to the dialogue request.

In the foregoing embodiment, when the character detection state transition information is consistent with the start state transition information, the compression state transition information is searched for corresponding character state transition information based on the start offset information and the to-be-matched character, so that a search range can be narrowed, thereby improving matching efficiency. In addition, the dialogue matching process is controlled based on the dialogue configuration parameter, so that the flexibility of dialogue matching can be improved.

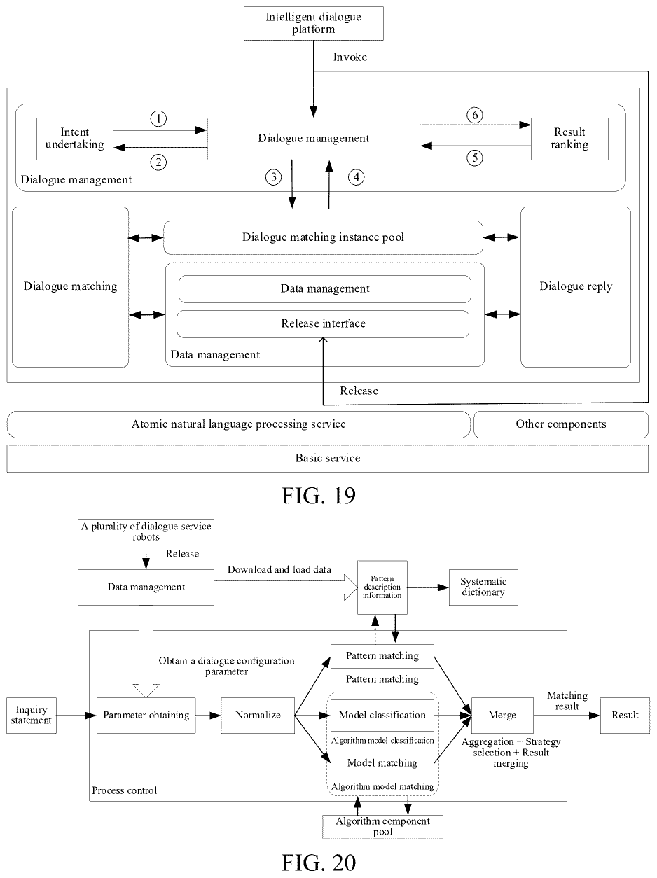

In a specific embodiment, the dialogue method is applied to an intelligent dialogue platform. FIG. 19 is a schematic diagram of an overall structure of a dialogue platform. The dialogue platform includes 5 components: a dialogue management component, a dialogue matching component, a data management component, a dialogue reply component, and a dialogue matching instance pool, which provides dialogue services applicable to various purposes and scenarios based on atomic natural language processing services, components, and basic services. The dialogue management component includes MGR (a dialogue management component), SkillSet (an intent undertaking component), and Ranker (a ranking component), and is responsible for dialogue management, intent undertaking, and ranking of results. Number 1 is that the dialogue management component obtains a dialogue request, and then obtains a plurality of pieces of intent, namely, a plurality of skills, corresponding to a dialogue service type from the intent undertaking component. Number 2 is that the intent undertaking component returns the plurality of pieces of intent corresponding to the obtained dialogue service type to the dialogue management component. Number 3 is that the dialogue management component performs dialogue matching on the plurality of pieces of intent corresponding to the obtained dialogue service type. Number 4 is that the dialogue management component obtains a result of the dialogue matching, namely, obtains a plurality of matched reply statements. Number 5 is that the dialogue management component ranks the plurality of matched reply statements based on a ranking result. Number 6 is that the dialogue management component obtains a final reply statement based on the ranking result and provides a reply. The dialogue matching component includes a DFA matching engine, a process control engine (SkillService), an algorithm component pool (AlgorithmModel), and a system dictionary (SysDect), and is responsible for a matching service of dialogue requests. The dialogue matching instance pool is a Nomad skill pool. The Nomad skill pool is a resource pool, in which a skill is instantiated and run in a memory for matching. The skill refers to a dialogue service type, and each dialogue service type has a corresponding skill. The dialogue reply component includes a CloudFunc cloud function component, a ThirdAPI third party interface, and FixedReply direct reply content, and is responsible for replying to a request obtained after a match hit. The data management component includes a DMS data management module and an API release interface, and is responsible for releasing of a dialogue service robot and a skill.

The dialogue method in this disclosure is implemented through dialogue matching component. FIG. 20 is a schematic diagram of an overall structure of dialogue matching, including four components: a pattern matching component (DFA matching), a process control component (SkillService), an algorithm component pool (AlgorithmModel), and a system dictionary (SysDect). The pattern matching component is configured to match with an inquiry statement, complete a matching task through an extraction capability of the system dictionary, and perform intent recognition and slot extraction. The process control component is responsible for matching process control while calling a DFA, and completes the process control of a matching process through a flexibly configured parameter and the algorithm component pool.

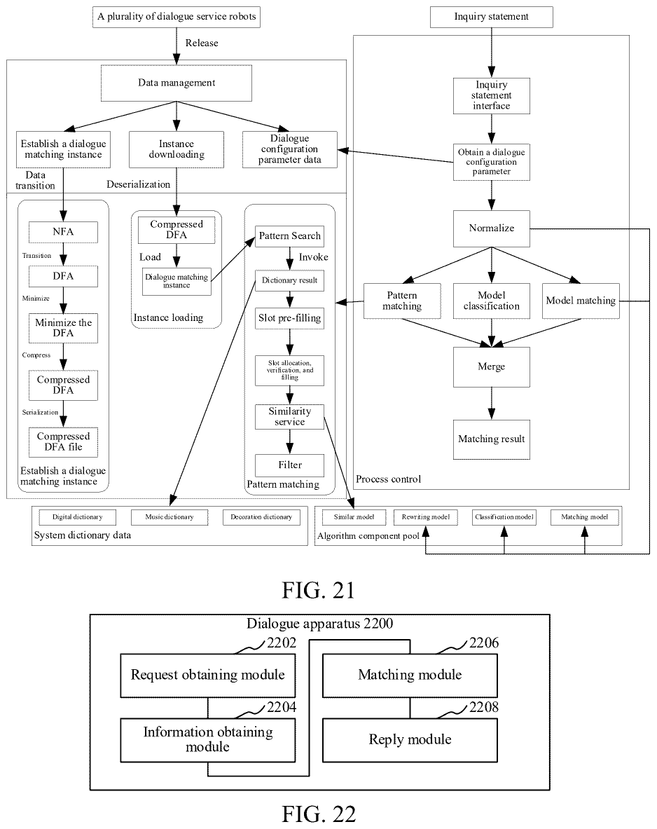

Further, FIG. 21 is a schematic diagram of a specific structure of dialogue matching. Specifically, a dialogue robot releasing party configures data of a plurality of dialogue service robots, the data including a dialogue configuration parameter and a plurality of pieces of dialogue pattern information. Then the dialogue server robots are released to an intelligent dialogue platform. The data management component in the intelligent dialogue platform calls a dialogue matching instance establishment service to establish a dialogue matching instance through a plurality of pieces of dialogue pattern information, where skill dialogue pattern information is first transitioned to a corresponding connected graph structure NFA, then the NFC graph is transitioned to an equivalent DFA graph through an NFC-to-DFA algorithm, and then reusable state nodes are merged to minimize the DFA graph, to obtain a minimized DFA graph. Then the minimized DFA graph is compressed in a compression manner of double-array trie, and an adjacency matrix corresponding to the minimized DFA graph is described through three arrays, to obtain the compressed DFA graph. Finally, the compressed DFA graph is packaged in a manner of serialization, to obtain a compressed DFA file, and the compressed DFA file is stored into a data management storage space. When loading the dialogue matching instance in the dialogue matching instance pool, the intelligent dialogue platform downloads the compressed DFA file from the data management storage space, and parses the compressed DFA file in a manner of p deserialization, to obtain a compressed DFA. Then, the compressed DFA is loaded for use in a to-be-matched process. When the inquiry statement is obtained, the control process component obtains the corresponding dialogue configuration parameter data from the data management storage space, performs service orchestration, and controls the matching process to start matching. To be specific, based on parameters such as symbol processing and error correction and rewriting, an algorithm error correction and rewriting service model and a symbol processing method are called to normalize the inquiry statement, to complete operations such as error correction, rewriting, and symbol processing. Then the pattern matching process is started based on a DFA matching parameter such as prefix and suffix matching or whether matching is complete, and parameters such as a pattern similarity, a pattern priority, and a slot popularity threshold. The pattern matching process includes quickly recalling a list of candidate dialogue pattern information through the compressed DFA. The system dictionary is invoked to obtain a system dictionary result corresponding to the candidate dialogue pattern information, and then slot filling is performed based on the system dictionary result. To be specific, slot filling control is performed through parameters such as a pattern similarity, a pattern similarity threshold, a slot popularity, a slot popularity threshold, and a quantity of slots, a slot matching priority, and system dictionary connectivity. An algorithm similarity service is called to complete the process of slot allocation, check, and slot filling to obtain a new list of dialogue pattern information. Finally, the new list of dialogue pattern information is ranked based on a parameter such as a pattern priority, and finally the dialogue pattern information ranked first is selected to obtain a pattern matching result. In addition, when the inquiry statement is obtained, the process control service concurrently calls the model classification service, the algorithm model matching service, and the like based on the algorithm model component pool parameter obtained from the data management storage space, to obtain the intent classification result corresponding to the classification model and the intent matching result corresponding to the matching model. Finally, all results are merged to output the final matching result.

Although the operations in the flowcharts involved in the embodiments described above are displayed in sequence as indicated by arrows, these operations are not necessarily performed in sequence as indicated by the arrows. Unless otherwise explicitly specified in this disclosure, execution of the operations is not strictly limited, and the operations may be performed in another sequence. Moreover, at least some of the operations in the flowcharts involved in the embodiments described above may include a plurality of operations or a plurality of stages. The operations or stages are not necessarily performed at the same moment but may be performed at different moments. These operations or stages are not necessarily successively performed, but may be performed alternately with other operations or at least part of operations of other operations or stages.

Based on the same inventive concept, an embodiment of this disclosure further provides a dialogue apparatus for implementing the foregoing dialogue method. An implementation solution provided by the apparatus for resolving the problem is similar to the implementation solution described in the foregoing method. Therefore, for specific limitations on one or more embodiments of the dialogue apparatus provided below, reference may be made to the limitations on the dialogue method above. Details are not described herein again.

In an embodiment, as shown in FIG. 22, a dialogue apparatus 2200 is provided, including a request obtaining module 2202, an information obtaining module 2204, a matching module 2206, and a reply module 2208.

The request obtaining module 2202 is configured to obtain a dialogue request, the dialogue request carrying an inquiry statement.

The information obtaining module 2204 is configured to obtain a dialogue service type based on the dialogue request, and obtain a corresponding dialogue configuration parameter and a plurality of pieces of pattern description information based on the dialogue service type, the pattern description information including pattern compression information and compression offset information, the pattern compression information being obtained by performing state transition on the dialogue pattern information through a DFA to obtain dialogue pattern state transition information and compressing target information in the dialogue pattern state transition information through non-target information in the dialogue pattern state transition information, and the compression offset information being configured for characterizing an offset of the non-target information in the dialogue pattern state transition information.

The matching module 2206 is configured to match the inquiry statement with the plurality of pieces of pattern description information based on the pattern compression information and the compression offset information, to obtain a plurality of pieces of candidate pattern description information.

The reply module 2208 is configured to: screen the plurality of pieces of candidate pattern description information based on the dialogue configuration parameter to obtain target pattern description information, obtain a reply statement associated with the target pattern description information, and return the reply statement to a requester side corresponding to the dialogue request.

In an embodiment, the dialogue apparatus 2200 further includes:
a compression module, configured to: obtain a plurality of pieces of dialogue pattern information corresponding to a dialogue service type; respectively perform state transition on the plurality of pieces of dialogue pattern information corresponding to the dialogue service type, to obtain dialogue pattern state transition information respectively corresponding to the plurality of pieces of dialogue pattern information; offset non-target information in the dialogue pattern state transition information respectively corresponding to the plurality of pieces of dialogue pattern information based on the target information in the dialogue pattern state transition information, to obtain offset dialogue pattern state transition information respectively corresponding to the plurality of pieces of dialogue pattern information; perform compression based on the offset dialogue pattern state transition information to obtain pattern compression information respectively corresponding to the plurality of pieces of dialogue pattern information, and determine compression offset information respectively corresponding to the plurality of pieces of dialogue pattern information based on the offset of the non-target information in the dialogue pattern state transition information; and obtain the pattern description information respectively corresponding to the plurality of pieces of dialogue pattern information based on the pattern compression information and the compression offset information.

In an embodiment, the compression module is further configured to: obtain current dialogue pattern information corresponding to the dialogue service type, and transition the current dialogue pattern information to a nondeterministic state connected graph, to obtain a current nondeterministic state connected graph; transition the current nondeterministic state connected graph to a deterministic state connected graph, to obtain the current deterministic state connected graph; and merge reused state nodes in the current deterministic state connected graph to obtain a target deterministic state connected graph, and obtain dialogue pattern state transition information corresponding to the current dialogue pattern information based on the target deterministic state connected graph.

In an embodiment, the dialogue apparatus 2200 further includes:
an instance loading module, configured to: perform a serialization operation on the pattern description information respectively corresponding to the plurality of pieces of dialogue pattern information, to obtain a serialized file, and store the serialized file into a data management storage space; obtain a dialogue matching instance establishment request, obtain the serialized file from the data management storage space based on the dialogue matching instance establishment request, and perform a deserialization operation on the serialized file to obtain the pattern description information respectively corresponding to the plurality of pieces of dialogue pattern information; and load the pattern description information respectively corresponding to the plurality of pieces of dialogue pattern information as a dialogue matching instance.

The information obtaining module 2204 is further configured to obtain, from the dialogue matching instance, the plurality of pieces of pattern description information corresponding to the dialogue service type.

In an embodiment, the dialogue apparatus 2200 further includes:
a service release module, configured to: obtain a dialogue service creation request, the dialogue service creation request carrying a dialogue service type; obtain a corresponding dialogue service creation page based on the dialogue service type, and return the dialogue service creation page to a requester side corresponding to the dialogue service creation request; obtain a dialogue service release request that is triggered through the requester side corresponding to the dialogue service creation request through the dialogue service creation page; and parse the dialogue service release request to obtain the plurality of pieces of dialogue pattern information corresponding to the dialogue service type and a dialogue configuration parameter corresponding to the dialogue service type, and store, into a data management space, the plurality of pieces of dialogue pattern information corresponding to the dialogue service type and the dialogue configuration parameter corresponding to the dialogue service type.

In an embodiment, the matching module 2206 is further configured to: perform a normalization operation on the inquiry statement based on a normalized parameter in the dialogue configuration parameter, to obtain a normalized statement; and match the normalized statement with the plurality of pieces of pattern description information based on the pattern compression information and the compression offset information, to obtain the plurality of pieces of candidate pattern description information.

In an embodiment, the matching module 2206 is further configured to: obtain start state transition information, and successively obtain a to-be-matched character from the normalized statement; search, based on the start state transition information, the pattern compression information and the compression offset information for character state transition information corresponding to the to-be-matched character; use the character state transition information as the start state transition information when the character state transition information meets a preset character matching condition, perform the operation of successively obtaining the to-be-matched character from the normalized statement, and obtain character state transition information corresponding to a termination character in the normalized statement until character traversal in the normalized statement is completed; and use pattern description information corresponding to the pattern compression information and the compression offset information as the candidate pattern description information when the character state transition information corresponding to the termination character meets a preset statement matching condition.

In an embodiment, the pattern compression information includes compression state transition information and detection state transition information corresponding to the compression state transition information.

The matching module 2206 is further configured to: search the compression offset information for start offset information corresponding to the start state transition information, search the detection state transition information for corresponding character detection state transition information based on the start offset information and the to-be-matched character, and search the compression state transition information for corresponding character state transition information based on the start offset information and the to-be-matched character when the character detection state transition information is consistent with the start state transition information.

In an embodiment, the reply module 2208 includes:
a screening module, configured to perform slot filling on the dialogue pattern information respectively corresponding to the plurality of pieces of candidate pattern description information based on a slot filling parameter in the dialogue configuration parameter, to obtain a plurality of pieces of dialogue intent information, and screen the plurality of pieces of dialogue intent information based on an intent screening parameter in the dialogue configuration parameter, to obtain target dialogue intent information; and
a statement reply module, configured to obtain a reply statement associated with the target dialogue intent information, and return the reply statement to the requester side corresponding to the dialogue request.

In an embodiment, the screening module is further configured to: determine a preset filling identifier in the dialogue pattern information, and obtain a plurality of pieces of to-be-filled information corresponding to the preset filling identifier; screen the plurality of pieces of to-be-filled information based on the slot filling parameter in the dialogue configuration parameter, to obtain target to-be-filled information corresponding to the preset filling identifier; and perform slot filling on the target to-be-filled information in the dialogue pattern information, to obtain dialogue intent information corresponding to the dialogue pattern information.

In an embodiment, the screening module is further configured to rank the plurality of pieces of dialogue intent information based on a pattern priority parameter in the dialogue configuration parameter, to obtain a dialogue intent information sequence, and select, from the dialogue intent information sequence, dialogue intent information ranked first, to obtain the target dialogue intent information.

In an embodiment, the statement reply module is further configured to: call a model classification service and a model matching service based on a model service parameter in the dialogue configuration parameter; perform intent classification on the inquiry statement based on the model classification service, to obtain classification intent information corresponding to the inquiry statement; perform intent matching on the inquiry statement based on the model matching service, to obtain matching intent information corresponding to the inquiry statement; merge the target dialogue intent information, the classification intent information, and the matching intent information to obtain final intent information; and obtain a target reply statement associated with the final intent information, and return the target reply statement to the requester side corresponding to the dialogue request.

In an embodiment, the statement reply module is further configured to: use the target dialogue intent information as the final intent information when the target dialogue intent information is consistent with the classification intent information; screen out, from the target dialogue intent information and the classification intent information, intent information that meets a preset intent condition when the target dialogue intent information is not consistent with the classification intent information; use, as the final intent information when the intent information meeting the preset intent condition exists, the intent information meeting the preset intent condition; and use the matching intent information as the final intent information when no intent information meeting the preset intent condition exists.

In an embodiment, the dialogue apparatus 2200 further includes:
a music dialogue module, configured to: obtain a dialogue request transmitted through a music dialogue page, the dialogue request carrying a music inquiry statement; obtain a music dialogue service type based on the dialogue request, and obtain a corresponding music dialogue configuration parameter and a plurality of pieces of music pattern description information based on the music dialogue service type, the music pattern description information including music pattern compression information and music compression offset information, the music pattern compression information being obtained by performing state transition on music dialogue pattern information to obtain music dialogue pattern state transition information and compressing target information in the music dialogue pattern state transition information, and the music compression offset information being configured for characterizing an offset of non-target information in the music dialogue pattern state transition information; match the music inquiry statement with the plurality of pieces of music pattern description information based on the music pattern compression information and the music compression offset information, to obtain a plurality of pieces of candidate music pattern description information; perform slot filling on the dialogue pattern information respectively corresponding to the plurality of pieces of candidate music pattern description information based on a slot filling parameter in the music dialogue configuration parameter, to obtain a plurality of pieces of music dialogue intent information, and screen the plurality of pieces of music dialogue intent information based on an intent screening parameter in the music dialogue configuration parameter, to obtain target music dialogue intent information; and obtain a music reply statement associated with the target music dialogue intent information, and display the music reply statement on the music dialogue page.

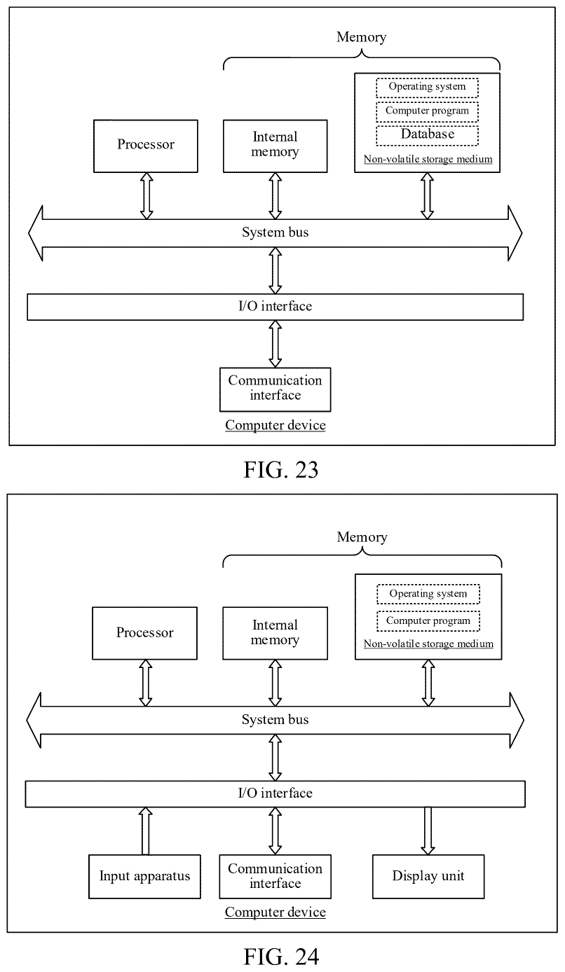

In an embodiment, a computer device is provided. The computer device may be a server, and an internal structural diagram thereof may be shown in FIG. 23. The computer device includes processing circuitry (e.g., a processor), a memory, an input/output (I/O for short) interface, and a communication interface. The processor, the memory, and the I/O interface are connected through a system bus, and the communication interface is connected to the system bus through the I/O interface. The processor of the computer device is configured to provide computing and control capabilities. The memory of the computer device includes a non-transitory computer-readable storage medium (e.g., a non-volatile storage medium) and an internal memory. The non-volatile storage medium stores an operating system, a computer program, and a database. The internal memory provides an environment for running of the operating system and the computer program in the non-volatile storage medium. The database of the computer device is configured to store data such as dialogue configuration parameter and a plurality of pieces of pattern description information. The I/O interface of the computer device is configured to exchange information between the processor and an external device. The communication interface of the computer device is configured to connect to and communicate with an external terminal through a network. The computer program, when executed by the processor, implements a dialogue method.

In an embodiment, a computer device is provided. The computer device may be a terminal, and an internal structure diagram thereof may be shown in FIG. 24. The computer device includes processing circuitry (e.g. a processor), a memory, an I/O interface, a communication interface, a display unit, and an input apparatus. The processor, the memory, and the I/O interface are connected through a system bus. The communication interface, the display unit, and the input apparatus are connected to the system bus through the I/O interface. The processor of the computer device is configured to provide computing and control capabilities. The memory of the computer device includes a non-transitory computer-readable storage medium (e.g., a non-volatile storage medium) and an internal memory. The non-volatile storage medium has an operating system and a computer program stored therein. The internal memory provides an environment for running of the operating system and the computer program in the non-volatile storage medium. The I/O interface of the computer device is configured to exchange information between the processor and an external device. The communication interface of the computer device is used for wired or wireless communication with an external terminal. The wireless communication may be implemented through Wi-Fi, a mobile cellular network, near field communication (NFC), or other technologies. The computer program, when executed by the processor, implements a dialogue method. The display unit of the computer device is configured to form a visually visible picture, and may be a display screen, a projection apparatus, or a virtual reality imaging apparatus. The display screen may be a liquid crystal display screen or an electronic ink display screen. The input apparatus of the computer device may be a touch layer covering the display screen, or may be a key, a trackball, or a touch pad arranged on a housing of the computer device, and may further be an external keyboard, a touch pad, a mouse, or the like.

A person skilled in the art may understand that, the structures shown in FIG. 23 and FIG. 24 are merely block diagrams of partial structures related to the solutions of this disclosure, and do not constitute a limitation to the computer device to which the solutions of this disclosure are applied. Specifically, the computer device may include more components or fewer components than those shown in the figure, or some merged components, or different component arrangements.

In an embodiment, a computer device is further provided, including a memory (e.g., a non-transitory computer-readable storage medium) and processing circuitry (e.g., a processor). The memory stores a computer program. The processor implements the operations in the foregoing method embodiments when executing the computer program.

In an embodiment, a non-transitory computer-readable storage medium is provided, having a computer program stored therein, the computer program, when executed by processing circuitry (e.g., a processor), implementing the operations in any one of the foregoing method embodiments.

In an embodiment, a computer program product is provided, including a computer program, the computer program, when executed by a processor, implementing the operations in the foregoing method embodiments.

A person of ordinary skill in the art may understand that all or some of processes of the method in the foregoing embodiments may be implemented by a computer program instructing relevant hardware. The computer program may be stored in a non-volatile computer-readable storage medium. When the computer program is executed, the processes of the foregoing method embodiments may be implemented. Any reference to a memory, a database, or another medium used in the embodiments provided in this disclosure may include at least one of a non-volatile memory and a volatile memory. The non-volatile memory may include a read-only memory (ROM), a magnetic tape, a floppy disk, a flash memory, an optical memory, a high density embedded non-volatile memory, a resistive random access memory (ReRAM), a magnetoresistive RAM (MRAM), a ferroelectric RAM (FRAM), a phase change memory (PCM), a graphene memory, and the like. The volatile memory may include a RAM, an external cache memory, or the like. As a description rather than a limitation, the RAM may have various forms, such as a static RAM (SRAM) or a dynamic RAM (DRAM). The database involved in the embodiments provided in this disclosure may include at least one of a relational database or a non-relational database. The non-relational database may include a blockchain-based distributed database, but is not limited thereto. The processor involved in the embodiments provided in this disclosure may be a general-purpose processor, a central processing unit, a graphics processing unit, a digital signal processor, a programmable logic device, a quantum computing-based data processing logic device, but is not limited thereto.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The technical features of the foregoing embodiments may be combined in different manners. To make the description concise, not all possible combinations of the technical features in the foregoing embodiments are described. However, the combinations of these technical features are considered to fall within the scope recorded in this specification provided that no conflict exists.

The foregoing embodiments merely show some implementations of this disclosure, and cannot be construed as a limitation on the scope of this disclosure. A person of ordinary skill in the art may make modifications, transformations, and improvements without departing from the concept of this disclosure. These modifications, transformations, and improvements fall within the scope of this disclosure.

What is claimed is:

1. A dialogue processing method, comprising:
obtaining a dialogue request, the dialogue request including an inquiry statement;
obtaining a dialogue service type based on the dialogue request;
obtaining a dialogue configuration parameter set and a plurality of pieces of pattern description information based on the dialogue service type, each of the plurality of pieces of pattern description information including respective pattern compression information and respective compression offset information, wherein, for each of the plurality of pieces of pattern description information:
the pattern compression information is obtained by performing state transition on respective dialogue pattern information through a deterministic finite automaton (DFA) to obtain dialogue pattern state transition information and compressing target information in the dialogue pattern state transition information and shifted non-target information in the dialogue pattern state transition information, and
the compression offset information indicates an offset of the shifted non-target information;
matching the inquiry statement with each of the plurality of pieces of pattern description information based on the respective pattern compression information and the respective compression offset information, to obtain one or more pieces of candidate pattern description information;
screening, by processing circuitry, the one or more pieces of candidate pattern description information based on the dialogue configuration parameter set to obtain target pattern description information; and
outputting, by the processing circuitry, a reply statement associated with the target pattern description information in response to the dialogue request.

2. The method according to claim 1, further comprising:
obtaining the plurality of pieces of dialogue pattern information corresponding to the dialogue service type; and
for each of the plurality of pieces of dialogue pattern information:
performing the state transition on the respective piece of dialogue pattern information through the DFA, to obtain the dialogue pattern state transition information corresponding to the respective piece of dialogue pattern information;
shifting the non-target information in the dialogue pattern state transition information based on the target information in the dialogue pattern state transition information, to obtain offset dialogue pattern state transition information;
performing compression based on the offset dialogue pattern state transition information to obtain the pattern compression information;
determining the compression offset information based on an offset of the shifted non-target information; and
obtaining the respective piece of pattern description information corresponding to the respective piece of dialogue pattern information based on the pattern compression information and the compression offset information.

3. The method according to claim 2, wherein, for each of the plurality of pieces of dialogue pattern information, the performing the state transition on the respective piece of dialogue pattern information comprises:
transitioning the respective piece of dialogue pattern information into a nondeterministic state connected graph, to obtain a current nondeterministic state connected graph;
transitioning the current nondeterministic state connected graph into a deterministic state connected graph, to obtain a current deterministic state connected graph;
merging reused state nodes in the current deterministic state connected graph to obtain a target deterministic state connected graph; and
obtaining the dialogue pattern state transition information corresponding to the respective piece of dialogue pattern information based on the target deterministic state connected graph.

4. The method according to claim 1, further comprising:
obtaining a dialogue matching instance establishment request;
obtaining a serialized file from a data management storage space based on the dialogue matching instance establishment request, the serialized file being based on a serialization of the plurality of pieces of pattern description information;
performing a deserialization operation on the serialized file to obtain the plurality of pieces of dialogue pattern information; and
loading each of the plurality of pieces of dialogue pattern information as a respective dialogue matching instance,
wherein the obtaining the plurality of pieces of pattern description information includes:
obtaining, from the respective dialogue matching instance, a respective piece of the plurality of pieces of pattern description information.

5. The method according to claim 1, further comprising:
obtaining a dialogue service creation request from a requester side, the dialogue service creation request indicating the dialogue service type;
outputting a dialogue service creation page corresponding to the dialogue service type to the requester side of the dialogue service creation request;
obtaining a dialogue service release request from the requester side through the dialogue service creation page;
parsing the dialogue service release request to obtain the plurality of pieces of dialogue pattern information corresponding to the dialogue service type and the dialogue configuration parameter set corresponding to the dialogue service type; and
storing, into a data management space, the plurality of pieces of dialogue pattern information corresponding to the dialogue service type and the dialogue configuration parameter set corresponding to the dialogue service type.

6. The method according to claim 1, wherein the matching the inquiry statement with each of the plurality of pieces of pattern description information comprises:
performing a normalization operation on the inquiry statement based on a normalized parameter in the dialogue configuration parameter set, to obtain a normalized statement; and
matching the normalized statement with each of the plurality of pieces of pattern description information based on the respective pattern compression information and the respective compression offset information, to obtain the one or more pieces of candidate pattern description information.

7. The method according to claim 6, wherein the matching the normalized statement with each of the plurality of pieces of pattern description information comprises, for each of the plurality of pieces of pattern description information:
obtaining start state transition information;
performing a first iteration, including:
obtaining a to-be-matched character for the first iteration that is a first character of the normalized statement; and
searching, based on the start state transition information, the pattern compression information and the compression offset information for character state transition information corresponding to the to-be-matched character for the first iteration;
performing one or more additional iterations when the character state transition information from a previous iteration meets a character matching condition, each iteration of the one or more additional iterations including:
obtaining to-be-matched character for the respective iteration from the normalized statement next to a previous to-be-matched character for the previous iteration; and
searching, based on the character state transition information from the previous iteration as start state transition information for the respective iteration, the pattern compression information and the compression offset information for character state transition information corresponding to the to-be-matched character for the respective iteration; and
when last character state transition information from last iteration based on a last character of the normalized statement meets a statement matching condition, determining the respective piece of the plurality of pieces of pattern description information as one of the one or more pieces of candidate pattern description information.

8. The method according to claim 7, wherein, for a piece of the plurality of pieces of pattern description information,
the pattern compression information includes compression state transition information and detection state transition information corresponding to the compression state transition information, and
the searching, based on the start state transition information for a respective iteration, the pattern compression information and the compression offset information includes:
searching the compression offset information for start offset information corresponding to the start state transition information for the respective iteration;
searching the detection state transition information for corresponding character detection state transition information based on the start offset information and the to-be-matched character for the respective iteration; and
searching the compression state transition information for the character state transition information for the respective iteration based on the start offset information and the to-be-matched character for the respective iteration when the character detection state transition information is consistent with the start state transition information for the respective iteration.

9. The method according to claim 1, wherein
the screening the one or more pieces of candidate pattern description information includes:
performing slot filling on the dialogue pattern information corresponding to each of the one or more pieces of candidate pattern description information based on a slot filling parameter in the dialogue configuration parameter set, to obtain one or more pieces of dialogue intent information; and
screening the one or more pieces of dialogue intent information based on an intent screening parameter in the dialogue configuration parameter set, to obtain target dialogue intent information corresponds to the target pattern description information, and
the outputting the reply statement includes:
obtaining the reply statement associated with the target dialogue intent information.

10. The method according to claim 9, wherein the performing slot filling on the dialogue pattern information corresponding to each of the one or more pieces of candidate pattern description information comprises:
determining a preset filling identifier in the dialogue pattern information;
obtaining a plurality of pieces of to-be-filled information corresponding to the preset filling identifier;
screening the plurality of pieces of to-be-filled information based on the slot filling parameter in the dialogue configuration parameter, to obtain target to-be-filled information corresponding to the preset filling identifier; and
performing slot filling on the target to-be-filled information in the dialogue pattern information, to obtain dialogue intent information corresponding to the dialogue pattern information.

11. The method according to claim 9, wherein the screening the one or more pieces of dialogue intent information comprises:
ranking the one or more dialogue intent information based on a pattern priority parameter in the dialogue configuration parameter set, to obtain a dialogue intent information sequence; and
selecting the dialogue intent information ranked first in the dialogue intent information sequence as the target dialogue intent information.

12. The method according to claim 9, wherein the obtaining the reply statement associated with the target dialogue intent information comprises:
identifying a model classification service and a model matching service based on a model service parameter in the dialogue configuration parameter set;
performing intent classification on the inquiry statement based on the model classification service, to obtain classification intent information corresponding to the inquiry statement;
performing intent matching on the inquiry statement based on the model matching service, to obtain matching intent information corresponding to the inquiry statement;
merging the target dialogue intent information, the classification intent information, and the matching intent information to obtain final intent information; and
obtaining the target reply statement based on the final intent information.

13. The method according to claim 12, wherein the merging the target dialogue intent information, the classification intent information, and the matching intent information comprises:
using the target dialogue intent information as the final intent information when the target dialogue intent information is consistent with the classification intent information; and
when the target dialogue intent information is not consistent with the classification intent information,
using the intent information as the final intent information when the intent information meets a preset intent condition exists, and
using the matching intent information as the final intent information when no intent information meets the preset intent condition.

14. The method according to claim 1, wherein
the dialogue request is a dialogue request transmitted through a music dialogue page,
the inquiry statement is a music inquiry statement,
the dialogue service type is a music dialogue service type,
the reply statement is a music reply statement, and
the outputting the reply statement includes displaying the music reply statement on the music dialogue page.

15. A dialogue processing apparatus, comprising:
processing circuitry configured to:
obtain a dialogue request, the dialogue request including an inquiry statement;
obtain a dialogue service type based on the dialogue request;
obtain a dialogue configuration parameter set and a plurality of pieces of pattern description information based on the dialogue service type, each of the plurality of pieces of pattern description information including respective pattern compression information and respective compression offset information, wherein, for each of the plurality of pieces of pattern description information:
the pattern compression information is obtained by performing state transition on respective dialogue pattern information through a deterministic finite automaton (DFA) to obtain dialogue pattern state transition information and compressing target information in the dialogue pattern state transition information and shifted non-target information in the dialogue pattern state transition information, and
the compression offset information indicates an offset of the shifted non-target information;
match the inquiry statement with each of the plurality of pieces of pattern description information based on the respective pattern compression information and the respective compression offset information, to obtain one or more pieces of candidate pattern description information;
screen the one or more pieces of candidate pattern description information based on the dialogue configuration parameter set to obtain target pattern description information; and
output a reply statement associated with the target pattern description information in response to the dialogue request.

16. The apparatus according to claim 15, wherein the processing circuitry is configured to:
obtain the plurality of pieces of dialogue pattern information corresponding to the dialogue service type; and
for each of the plurality of pieces of dialogue pattern information:
perform the state transition on the respective piece of dialogue pattern information through the DFA, to obtain the dialogue pattern state transition information corresponding to the respective piece of dialogue pattern information;
shift the non-target information in the dialogue pattern state transition information based on the target information in the dialogue pattern state transition information, to obtain offset dialogue pattern state transition information;
perform compression based on the offset dialogue pattern state transition information to obtain the pattern compression information;
determine the compression offset information based on an offset of the shifted non-target information; and
obtain the respective piece of pattern description information corresponding to the respective piece of dialogue pattern information based on the pattern compression information and the compression offset information.

17. The apparatus according to claim 15, wherein the processing circuitry is configured to:
obtain a dialogue matching instance establishment request;
obtain a serialized file from a data management storage space based on the dialogue matching instance establishment request, the serialized file being based on a serialization of the plurality of pieces of pattern description information;
perform a deserialization operation on the serialized file to obtain the plurality of pieces of dialogue pattern information;
load each of the plurality of pieces of dialogue pattern information as a respective dialogue matching instance; and
obtain, from the respective dialogue matching instance, a respective piece of the plurality of pieces of pattern description information.

18. The apparatus according to claim 15, wherein the processing circuitry is configured to:
obtain a dialogue service creation request from a requester side, the dialogue service creation request indicating the dialogue service type;
output a dialogue service creation page corresponding to the dialogue service type to the requester side of the dialogue service creation request;
obtain a dialogue service release request from the requester side through the dialogue service creation page;
parse the dialogue service release request to obtain the plurality of pieces of dialogue pattern information corresponding to the dialogue service type and the dialogue configuration parameter set corresponding to the dialogue service type; and
store, into a data management space, the plurality of pieces of dialogue pattern information corresponding to the dialogue service type and the dialogue configuration parameter set corresponding to the dialogue service type.

19. The apparatus according to claim 15, wherein the processing circuitry is configured to:
perform a normalization operation on the inquiry statement based on a normalized parameter in the dialogue configuration parameter set, to obtain a normalized statement; and
match the normalized statement with each of the plurality of pieces of pattern description information based on the respective pattern compression information and the respective compression offset information, to obtain the one or more pieces of candidate pattern description information.

20. A non-transitory computer-readable storage medium storing instructions, which when executed by a processor, cause the processor to perform a dialogue processing method comprising:
obtaining a dialogue request, the dialogue request including an inquiry statement;
obtaining a dialogue service type based on the dialogue request;
obtaining a dialogue configuration parameter set and a plurality of pieces of pattern description information based on the dialogue service type, each of the plurality of pieces of pattern description information including respective pattern compression information and respective compression offset information, wherein, for each of the plurality of pieces of pattern description information:
the pattern compression information is obtained by performing state transition on respective dialogue pattern information through a deterministic finite automaton (DFA) to obtain dialogue pattern state transition information and compressing target information in the dialogue pattern state transition information and shifted non-target information in the dialogue pattern state transition information, and
the compression offset information indicates an offset of the shifted non-target information;
matching the inquiry statement with each of the plurality of pieces of pattern description information based on the respective pattern compression information and the respective compression offset information, to obtain one or more pieces of candidate pattern description information;
screening the one or more pieces of candidate pattern description information based on the dialogue configuration parameter set to obtain target pattern description information; and
outputting a reply statement associated with the target pattern description information in response to the dialogue request.
